(19) United States
(12) Patent Application Publication
(10) Pub. No.: US 2026/0059442 A1
(43) Pub. Date: Feb. 26, 2026

(54) SIGNALING FOR CALL CONTINUITY IN WIRELESS COMMUNICATION SYSTEMS

(71) Applicant: QUALCOMM Incorporated, San Diego, CA (US)

(72) Inventors: Hargovind Prasad BANSAL, Bharatpur (IN); Tom CHIN, San Diego, CA (US); Rajeev PAL, San Diego, CA (US); Muralidharan MURUGAN, Hyderabad (IN); Vimal SINGH, Hyderabad (IN); Ravinder ARE, Hyderabad (IN)

(21) Appl. No.: 19/105,098

(22) PCT Filed: Feb. 27, 2023
(86) PCT No.: PCT/US2023/013950

§ 371 Date: Feb. 20, 2025

(30) Foreign Application Priority Data
Oct. 31, 2022 (IN) 202241061868

(51) Int. Cl. H04W 52/02

(52) U.S. Cl. CPC H04W 52/0216

(57) ABSTRACT

Wireless communications systems, apparatuses, and methods are provided. A method of wireless communication performed by a user equipment (UE) includes transmitting, to a network unit, an indicator indicating an expected outage, starting an outage timer based on the indicator, and refraining from communicating for a duration of the outage timer.

### CROSS-REFERENCE TO A RELATED APPLICATION

This application claims priority to and the benefit of Indian Provisional Patent Application No. 202241061868, filed Oct. 31, 2022, the disclosure of which is referenced herein as if fully set forth below and for all applicable purposes.

### TECHNICAL FIELD

This application relates to wireless communication systems, and more particularly, to signaling for call continuity in wireless communication systems.

### INTRODUCTION

Wireless communications systems are widely deployed to provide various types of communication content such as voice, video, packet data, messaging, broadcast, and so on. These systems may be capable of supporting communication with multiple users by sharing the available system resources (e.g., time, frequency, and power). A wireless multiple-access communications system may include a number of base stations (BSs), each simultaneously supporting communications for multiple communication devices, which may be otherwise known as user equipment (UE).

To meet the growing demands for expanded mobile broadband connectivity, wireless communication technologies are advancing from the LTE technology to a next generation new radio (NR) technology. For example, NR is designed to provide a lower latency, a higher bandwidth or throughput, and a higher reliability than LTE. NR is designed to operate over a wide array of spectrum bands, for example, from low-frequency bands below about 1 gigahertz (GHz) and mid-frequency bands from about 1 GHz to about 6 GHz, to high-frequency bands such as millimeter wave (mmWave) bands. NR is also designed to operate across different spectrum types, from licensed spectrum to unlicensed and shared spectrum. Spectrum sharing enables operators to opportunistically aggregate spectrums to dynamically support high-bandwidth services. Spectrum sharing can extend the benefit of NR technologies to operating entities that may not have access to a licensed spectrum.

NR may support various deployment scenarios to benefit from the various spectrums in different frequency ranges, licensed and/or unlicensed, and/or coexistence of the LTE and NR technologies. For example, NR can be deployed in a standalone NR mode over a licensed and/or an unlicensed band or in a dual connectivity mode with various combinations of NR and LTE over licensed and/or unlicensed bands.

In a wireless communication network, a BS may communicate with a UE in an uplink direction and a downlink direction. Sidelink was introduced in LTE to allow a UE to send data to another UE (e.g., from one vehicle to another vehicle) without tunneling through the BS and/or an associated core network. The LTE sidelink technology has been extended to provision for device-to-device (D2D) communications, vehicle-to-everything (V2X) communications, and/or cellular vehicle-to-everything (C-V2X) communications. Similarly, NR may be extended to support sidelink communications, D2D communications, V2X communications, and/or C-V2X over licensed frequency bands and/or unlicensed frequency bands (e.g., shared frequency bands).

### BRIEF SUMMARY OF SOME EXAMPLES

The following summarizes some aspects of the present disclosure to provide a basic understanding of the discussed technology. This summary is not an extensive overview of all contemplated features of the disclosure and is intended neither to identify key or critical elements of all aspects of the disclosure nor to delineate the scope of any or all aspects of the disclosure. Its sole purpose is to present some concepts of one or more aspects of the disclosure in summary form as a prelude to the more detailed description that is presented later.

In an aspect of the disclosure, a method of wireless communication performed by a user equipment (UE) may include transmitting, to a network unit, an indicator indicating an expected outage; starting an outage timer based on the indicator; and refraining from communicating for a duration of the outage timer.

In an additional aspect of the disclosure, a method of wireless communication performed by a network unit may include receiving, from a user equipment (UE), an indicator indicating an expected outage; starting an outage timer based on the indicator; and refraining from communicating with the UE for a duration of the outage timer.

In an additional aspect of the disclosure, a user equipment (UE) may include a memory; a transceiver; and at least one processor coupled to the memory and the transceiver, wherein the UE is configured to transmit, to a network unit, an indicator indicating an expected outage; start an outage timer based on the indicator; and refrain from communicating for a duration of the outage timer.

In an additional aspect of the disclosure, a network unit may include a memory; a transceiver; and at least one processor coupled to the memory and the transceiver, wherein the network unit is configured to receive, from a user equipment (UE), an indicator indicating an expected outage; start an outage timer based on the indicator; and refrain from communicating with the UE for a duration of the outage timer.

Other aspects, features, and instances of the present invention will become apparent to those of ordinary skill in the art, upon reviewing the following description of specific, exemplary instances of the present invention in conjunction with the accompanying figures. While features of the present invention may be discussed relative to certain aspects and figures below, all instances of the present invention can include one or more of the advantageous features discussed herein. In other words, while one or more instances may be discussed as having certain advantageous features, one or more of such features may also be used in accordance with the various instances of the invention discussed herein. In similar fashion, while exemplary aspects may be discussed below as device, system, or method instances it should be understood that such exemplary instances can be implemented in various devices, systems, and methods.

### BRIEF DESCRIPTION OF THE DRAWINGS

FIG. 1 illustrates a wireless communication network according to some aspects of the present disclosure.

FIG. 2 illustrates an example disaggregated base station architecture according to some aspects of the present disclosure.

FIG. 3 illustrates service outage areas in a wireless communication network according to some aspects of the present disclosure.

FIG. 4 illustrates location determination methods associated with a UE according to some aspects of the present disclosure.

FIG. 5 illustrates a call continuity timeline in a wireless communication network according to some aspects of the present disclosure.

FIG. 6 is a signal flow diagram of a communication method according to some aspects of the present disclosure.

FIG. 7 is a signal flow diagram of a communication method according to some aspects of the present disclosure.

FIG. 8 is a block diagram of an exemplary user equipment (UE) according to some aspects of the present disclosure.

FIG. 9 is a block diagram of an exemplary network unit according to some aspects of the present disclosure.

FIG. 10 is a flow diagram of a communication method according to some aspects of the present disclosure.

FIG. 11 is a flow diagram of a communication method according to some aspects of the present disclosure.

### DETAILED DESCRIPTION

The detailed description set forth below, in connection with the appended drawings, is intended as a description of various configurations and is not intended to represent the only configurations in which the concepts described herein may be practiced. The detailed description includes specific details for the purpose of providing a thorough understanding of the various concepts. However, it will be apparent to those skilled in the art that these concepts may be practiced without these specific details. In some instances, well-known structures and components are shown in block diagram form in order to avoid obscuring such concepts.

This disclosure relates generally to wireless communications systems, also referred to as wireless communications networks. In various instances, the techniques and apparatus may be used for wireless communication networks such as code division multiple access (CDMA) networks, time division multiple access (TDMA) networks, frequency division multiple access (FDMA) networks, orthogonal FDMA (OFDMA) networks, single-carrier FDMA (SC-FDMA) networks, LTE networks, GSM networks, 5^{th} Generation (5G) or new radio (NR) networks, as well as other communications networks. As described herein, the terms “networks” and “systems” may be used interchangeably.

An OFDMA network may implement a radio technology such as evolved UTRA (E-UTRA), Institute of Electrical and Electronic Engineers (IEEE) 802.11, IEEE 802.16, IEEE 802.20, flash-OFDM and the like. UTRA, E-UTRA, and Global System for Mobile Communications (GSM) are part of universal mobile telecommunication system (UMTS). In particular, long term evolution (LTE) is a release of UMTS that uses E-UTRA. UTRA, E-UTRA, GSM, UMTS and LTE are described in documents provided from an organization named “3^{rd} Generation Partnership Project” (3GPP), and cdma2000 is described in documents from an organization named “3^{rd} Generation Partnership Project 2” (3GPP2). These various radio technologies and standards are known or are being developed. For example, the 3^{rd} Generation Partnership Project (3GPP) is a collaboration between groups of telecommunications associations that aims to define a globally applicable third generation (3G) mobile phone specification. 3GPP long term evolution (LTE) is a 3GPP project which was aimed at improving the universal mobile telecommunications system (UMTS) mobile phone standard. The 3GPP may define specifications for the next generation of mobile networks, mobile systems, and mobile devices. The present disclosure is concerned with the evolution of wireless technologies from LTE, 4G, 5G, NR, and beyond with shared access to wireless spectrum between networks using a collection of new and different radio access technologies or radio air interfaces.

In particular, 5G networks contemplate diverse deployments, diverse spectrum, and diverse services and devices that may be implemented using an OFDM-based unified, air interface. In order to achieve these goals, further enhancements to LTE and LTE-A are considered in addition to development of the new radio technology for 5G NR networks. The 5G NR will be capable of scaling to provide coverage (1) to a massive Internet of things (IoTs) with an ultra-high density (e.g., ˜1 M nodes/km2), ultra-low complexity (e.g., ˜10 s of bits/sec), ultra-low energy (e.g., ˜10+years of battery life), and deep coverage with the capability to reach challenging locations; (2) including mission-critical control with strong security to safeguard sensitive personal, financial, or classified information, ultra-high reliability (e.g., ˜99.9999% reliability), ultra-low latency (e.g., ˜1 ms), and users with wide ranges of mobility or lack thereof; and (3) with enhanced mobile broadband including extreme high capacity (e.g., ˜10 Tbps/km2), extreme data rates (e.g., multi-Gbps rate, 100+ Mbps user experienced rates), and deep awareness with advanced discovery and optimizations.

The 5G NR may be implemented to use optimized OFDM-based waveforms with scalable numerology and transmission time interval (TTI); having a common, flexible framework to efficiently multiplex services and features with a dynamic, low-latency time division duplex (TDD)/frequency division duplex (FDD) design; and with advanced wireless technologies, such as massive multiple input, multiple output (MIMO), robust millimeter wave (mmWave) transmissions, advanced channel coding, and device-centric mobility. Scalability of the numerology in 5G NR, with scaling of subcarrier spacing, may efficiently address operating diverse services across diverse spectrum and diverse deployments. For example, in various outdoor and macro coverage deployments of less than 3 GHz FDD/TDD implementations, subcarrier spacing may occur with 15 kHz, for example over 5, 10, 20 MHz, and the like bandwidth (BW). For other various outdoor and small cell coverage deployments of TDD greater than 3 GHZ, subcarrier spacing may occur with 30 kHz over 80/100 MHZ BW. For other various indoor wideband implementations, using a TDD over the unlicensed portion of the 5 GHz band, the subcarrier spacing may occur with 60 kHz over a 160 MHz BW. Finally, for various deployments transmitting with mmWave components at a TDD of 28 GHz, subcarrier spacing may occur with 120 kHz over a 500 MHz BW.

The scalable numerology of the 5G NR facilitates scalable TTI for diverse latency and quality of service (QOS) requirements. For example, shorter TTI may be used for low latency and high reliability, while longer TTI may be used for higher spectral efficiency. The efficient multiplexing of long and short TTIs to allow transmissions to start on symbol boundaries. 5G NR also contemplates a self-contained integrated subframe design with uplink/downlink scheduling information, data, and acknowledgement in the same subframe. The self-contained integrated subframe supports communications in unlicensed or contention-based shared spectrum, adaptive uplink/downlink that may be flexibly configured on a per-cell basis to dynamically switch between uplink and downlink to meet the current traffic needs.

Various other aspects and features of the disclosure are further described below. It should be apparent that the teachings herein may be embodied in a wide variety of forms and that any specific structure, function, or both being disclosed herein is merely representative and not limiting. Based on the teachings herein one of an ordinary level of skill in the art should appreciate that an aspect disclosed herein may be implemented independently of any other aspects and that two or more of these aspects may be combined in various ways. For example, an apparatus may be implemented or a method may be practiced using any number of the aspects set forth herein. In addition, such an apparatus may be implemented or such a method may be practiced using other structure, functionality, or structure and functionality in addition to or other than one or more of the aspects set forth herein. For example, a method may be implemented as part of a system, device, apparatus, and/or as instructions stored on a computer readable medium for execution on a processor or computer. Furthermore, an aspect may comprise at least one element of a claim.

The deployment of NR over an unlicensed spectrum is referred to as NR-unlicensed (NR-U). Federal Communications Commission (FCC) and European Telecommunications Standards Institute (ETSI) are working on regulating 6 GHz as a new unlicensed band for wireless communications. The addition of 6 GHz bands allows for hundreds of megahertz (MHz) of bandwidth (BW) available for unlicensed band communications. Additionally, NR-U can also be deployed over 2.4 GHz unlicensed bands, which are currently shared by various radio access technologies (RATs), such as IEEE 802.11 wireless local area network (WLAN) or WiFi and/or license assisted access (LAA). Sidelink communications may benefit from utilizing the additional bandwidth available in an unlicensed spectrum. However, channel access in a certain unlicensed spectrum may be regulated by authorities. For instance, some unlicensed bands may impose restrictions on the power spectral density (PSD) and/or minimum occupied channel bandwidth (OCB) for transmissions in the unlicensed bands. For example, the unlicensed national information infrastructure (UNII) radio band has a minimum OCB requirement of about at least 70 percent (%).

Some sidelink systems may operate over a 20 MHz bandwidth, e.g., for listen before talk (LBT) based channel accessing, in an unlicensed band. A BS may configure a sidelink resource pool over one or multiple 20 MHz LBT sub-bands for sidelink communications. A sidelink resource pool is typically allocated with multiple frequency subchannels within a sidelink band width part (SL-BWP) and a sidelink UE may select a sidelink resource (e.g., one or multiple subchannel) in frequency and one or multiple slots in time) from the sidelink resource pool for sidelink communication.

Deployment of communication systems, such as 5G new radio (NR) systems, may be arranged in multiple manners with various components or constituent parts. In a 5G NR system, or network, a network node, a network entity, a mobility element of a network, a radio access network (RAN) node, a core network node, a network element, or a network equipment, such as a base station (BS), or one or more units (or one or more components) performing base station functionality, may be implemented in an aggregated or disaggregated architecture. For example, a BS (such as a Node B (NB), evolved NB (eNB), NR BS, 5G NB, access point (AP), a transmit receive point (TRP), or a cell, etc.) may be implemented as an aggregated base station (also known as a standalone BS or a monolithic BS) or a disaggregated base station.

An aggregated base station may be configured to utilize a radio protocol stack that is physically or logically integrated within a single RAN node. A disaggregated base station may be configured to utilize a protocol stack that is physically or logically distributed among two or more units (such as one or more central or centralized units (CUs), one or more distributed units (DUs) , or one or more radio units (RUs)). In some aspects, a CU may be implemented within a RAN node, and one or more DUs may be co-located with the CU, or alternatively, may be geographically or virtually distributed throughout one or multiple other RAN nodes. The DUs may be implemented to communicate with one or more RUs. Each of the CU, DU and RU also can be implemented as virtual units, i.e., a virtual central unit (VCU), a virtual distributed unit (VDU), or a virtual radio unit (VRU).

Base station-type operation or network design may consider aggregation characteristics of base station functionality. For example, disaggregated base stations may be utilized in an integrated access backhaul (IAB) network, an open radio access network (O-RAN (such as the network configuration sponsored by the O-RAN Alliance)), or a virtualized radio access network (vRAN, also known as a cloud radio access network (C-RAN)). Disaggregation may include distributing functionality across two or more units at various physical locations, as well as distributing functionality for at least one unit virtually, which can enable flexibility in network design. The various units of the disaggregated base station, or disaggregated RAN architecture, can be configured for wired or wireless communication with at least one other unit.

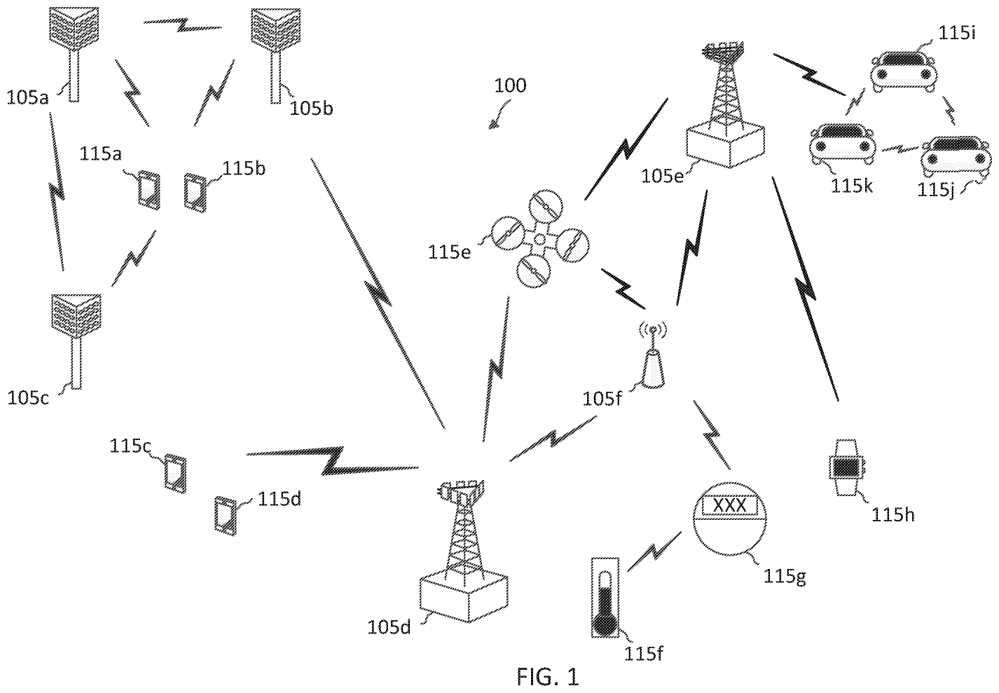

FIG. 1 illustrates a wireless communication network 100 according to some aspects of the present disclosure. The network 100 includes a number of base stations (BSs) 105 and other network entities. A BS 105 may be a station that communicates with UEs 115 and may also be referred to as an evolved node B (eNB), a next generation eNB (gNB), an access point, and the like. Each BS 105 may provide communication coverage for a particular geographic area. In 3GPP, the term “cell” can refer to this particular geographic coverage area of a BS 105 and/or a BS subsystem serving the coverage area, depending on the context in which the term is used.

A BS 105 may provide communication coverage for a macro cell or a small cell, such as a pico cell or a femto cell, and/or other types of cell. A macro cell generally covers a relatively large geographic area (e.g., several kilometers in radius) and may allow unrestricted access by UEs with service subscriptions with the network provider. A small cell, such as a pico cell, would generally cover a relatively smaller geographic area and may allow unrestricted access by UEs with service subscriptions with the network provider. A small cell, such as a femto cell, would also generally cover a relatively small geographic area (e.g., a home) and, in addition to unrestricted access, may also provide restricted access by UEs having an association with the femto cell (e.g., UEs in a closed subscriber group (CSG), UEs for users in the home, and the like). A BS for a macro cell may be referred to as a macro BS. A BS for a small cell may be referred to as a small cell BS, a pico BS, a femto BS or a home BS. In the example shown in FIG. 1, the BSs 105d and 105e may be regular macro BSs, while the BSs 105a-105c may be macro BSs enabled with one of three dimension (3D), full dimension (FD), or massive MIMO. The BSs 105a-105c may take advantage of their higher dimension MIMO capabilities to exploit 3D beamforming in both elevation and azimuth beamforming to increase coverage and capacity. The BS 105f may be a small cell BS which may be a home node or portable access point. A BS 105 may support one or multiple (e.g., two, three, four, and the like) cells.

The network 100 may support synchronous or asynchronous operation. For synchronous operation, the BSs may have similar frame timing, and transmissions from different BSs may be approximately aligned in time. For asynchronous operation, the BSs may have different frame timing, and transmissions from different BSs may not be aligned in time.

The UEs 115 are dispersed throughout the wireless network 100, and each UE 115 may be stationary or mobile. A UE 115 may also be referred to as a terminal, a mobile station, a subscriber unit, a station, or the like. A UE 115 may be a cellular phone, a personal digital assistant (PDA), a wireless modem, a wireless communication device, a handheld device, a tablet computer, a laptop computer, a cordless phone, a wireless local loop (WLL) station, or the like. In one aspect, a UE 115 may be a device that includes a Universal Integrated Circuit Card (UICC). In another aspect, a UE may be a device that does not include a UICC. In some aspects, the UEs 115 that do not include UICCs may also be referred to as IoT devices or internet of everything (IoE) devices. The UEs 115a-115d are examples of mobile smart phone-type devices accessing network 100. A UE 115 may also be a machine specifically configured for connected communication, including machine type communication (MTC), enhanced MTC (eMTC), narrowband IoT (NB-IOT) and the like. The UEs 115e-115h are examples of various machines configured for communication that access the network 100. The UEs 115i-115k are examples of vehicles equipped with wireless communication devices configured for communication that access the network 100. A UE 115 may be able to communicate with any type of the BSs, whether macro BS, small cell, or the like. In FIG. 1, a lightning bolt (e.g., communication links) indicates wireless transmissions between a UE 115 and a serving BS 105, which is a BS designated to serve the UE 115 on the downlink (DL) and/or uplink (UL), desired transmission between BSs 105, backhaul transmissions between BSs, or sidelink transmissions between UEs 115.

In operation, the BSs 105a-105c may serve the UEs 115a and 115b using 3D beamforming and coordinated spatial techniques, such as coordinated multipoint (CoMP) or multi-connectivity. The macro BS 105d may perform backhaul communications with the BSs 105a-105c, as well as small cell, the BS 105f. The macro BS 105d may also transmits multicast services which are subscribed to and received by the UEs 115c and 115d. Such multicast services may include mobile television or stream video, or may include other services for providing community information, such as weather emergencies or alerts, such as Amber alerts or gray alerts.

The BSs 105 may also communicate with a core network. The core network may provide user authentication, access authorization, tracking, Internet Protocol (IP) connectivity, and other access, routing, or mobility functions. At least some of the BSs 105 (e.g., which may be an example of an evolved NodeB (eNB) or an access node controller (ANC)) may interface with the core network 130 through backhaul links (e.g., S1, S2, etc.) and may perform radio configuration and scheduling for communication with the UEs 115. In various examples, the BSs 105 may communicate, either directly or indirectly (e.g., through core network), with each other over backhaul links (e.g., X1, X2, etc.), which may be wired or wireless communication links.

The network 100 may also support mission critical communications with ultra-reliable and redundant links for mission critical devices, such as the UE 115e, which may be a vehicle (e.g., a car, a truck, a bus, an autonomous vehicle, an aircraft, a boat, etc.). Redundant communication links with the UE 115e may include links from the macro BSs 105d and 105e, as well as links from the small cell BS 105f. Other machine type devices, such as the UE 115f (e.g., a thermometer), the UE 115g (e.g., smart meter), and UE 115h (e.g., wearable device) may communicate through the network 100 either directly with BSs, such as the small cell BS 105f, and the macro BS 105e, or in multi-hop configurations by communicating with another user device which relays its information to the network, such as the UE 115f communicating temperature measurement information to the smart meter, the UE 115g, which is then reported to the network through the small cell BS 105f. In some aspects, the UE 115h may harvest energy from an ambient environment associated with the UE 115h. The network 100 may also provide additional network efficiency through dynamic, low-latency TDD/FDD communications, such as vehicle-to-vehicle (V2V), vehicle-to-everything (V2X), cellular-vehicle-to-everything (C-V2X) communications between a UE 115i, 115j, or 115k and other UEs 115, and/or vehicle-to-infrastructure (V2I) communications between a UE 115i, 115j, or 115k and a BS 105.

In some implementations, the network 100 utilizes OFDM-based waveforms for communications. An OFDM-based system may partition the system BW into multiple (K) orthogonal subcarriers, which are also commonly referred to as subcarriers, tones, bins, or the like. Each subcarrier may be modulated with data. In some instances, the subcarrier spacing between adjacent subcarriers may be fixed, and the total number of subcarriers (K) may be dependent on the system BW. The system BW may also be partitioned into subbands. In other instances, the subcarrier spacing and/or the duration of TTIs may be scalable.

In some instances, the BSs 105 can assign or schedule transmission resources (e.g., in the form of time-frequency resource blocks (RB)) for downlink (DL) and uplink (UL) transmissions in the network 100. DL refers to the transmission direction from a BS 105 to a UE 115, whereas UL refers to the transmission direction from a UE 115 to a BS 105. The communication can be in the form of radio frames. A radio frame may be divided into a plurality of subframes, for example, about 10. Each subframe can be divided into slots, for example, about 2. Each slot may be further divided into mini-slots. In a FDD mode, simultaneous UL and DL transmissions may occur in different frequency bands. For example, each subframe includes a UL subframe in a UL frequency band and a DL subframe in a DL frequency band. In a TDD mode, UL and DL transmissions occur at different time periods using the same frequency band. For example, a subset of the subframes (e.g., DL subframes) in a radio frame may be used for DL transmissions and another subset of the subframes (e.g., UL subframes) in the radio frame may be used for UL transmissions.

The DL subframes and the UL subframes can be further divided into several regions. For example, each DL or UL subframe may have pre-defined regions for transmissions of reference signals, control information, and data. Reference signals are predetermined signals that facilitate the communications between the BSs 105 and the UEs 115. For example, a reference signal can have a particular pilot pattern or structure, where pilot tones may span across an operational BW or frequency band, each positioned at a pre-defined time and a pre-defined frequency. For example, a BS 105 may transmit cell specific reference signals (CRSs) and/or channel state information-reference signals (CSI-RSs) to enable a UE 115 to estimate a DL channel. Similarly, a UE 115 may transmit sounding reference signals (SRSs) to enable a BS 105 to estimate a UL channel. Control information may include resource assignments and protocol controls. Data may include protocol data and/or operational data. In some instances, the BSs 105 and the UEs 115 may communicate using self-contained subframes. A self-contained subframe may include a portion for DL communication and a portion for UL communication. A self-contained subframe can be DL-centric or UL-centric. A DL-centric subframe may include a longer duration for DL communication than for UL communication. A UL-centric subframe may include a longer duration for UL communication than for UL communication.

In some instances, the network 100 may be an NR network deployed over a licensed spectrum. The BSs 105 can transmit synchronization signals (e.g., including a primary synchronization signal (PSS) and a secondary synchronization signal (SSS)) in the network 100 to facilitate synchronization. The BSs 105 can broadcast system information associated with the network 100 (e.g., including a master information block (MIB), remaining minimum system information (RMSI), and other system information (OSI)) to facilitate initial network access. In some instances, the BSs 105 may broadcast the PSS, the SSS, and/or the MIB in the form of synchronization signal blocks (SSBs) over a physical broadcast channel (PBCH) and may broadcast the RMSI and/or the OSI over a physical downlink shared channel (PDSCH).

In some instances, a UE 115 attempting to access the network 100 may perform an initial cell search by detecting a PSS from a BS 105. The PSS may enable synchronization of period timing and may indicate a physical layer identity value. The UE 115 may then receive an SSS. The SSS may enable radio frame synchronization, and may provide a cell identity value, which may be combined with the physical layer identity value to identify the cell. The SSS may also enable detection of a duplexing mode and a cyclic prefix length. The PSS and the SSS may be located in a central portion of a carrier or any suitable frequencies within the carrier.

After receiving the PSS and SSS, the UE 115 may receive a MIB. The MIB may include system information for initial network access and scheduling information for RMSI and/or OSI. After decoding the MIB, the UE 115 may receive RMSI and/or OSI. The RMSI and/or OSI may include radio resource control (RRC) information related to random access channel (RACH) procedures, paging, control resource set (CORESET) for physical downlink control channel (PDCCH) monitoring, physical uplink control channel (PUCCH), physical uplink shared channel (PUSCH), power control, SRS, and cell barring.

After obtaining the MIB, the RMSI and/or the OSI, the UE 115 can perform a random access procedure to establish a connection with the BS 105. For the random access procedure, the UE 115 may transmit a random access preamble and the BS 105 may respond with a random access response. Upon receiving the random access response, the UE 115 may transmit a connection request to the BS 105 and the BS 105 may respond with a connection response (e.g., contention resolution message).

After establishing a connection, the UE 115 and the BS 105 can enter a normal operation stage, where operational data may be exchanged. For example, the BS 105 may schedule the UE 115 for UL and/or DL communications. The BS 105 may transmit UL and/or DL scheduling grants to the UE 115 via a PDCCH. The BS 105 may transmit a DL communication signal to the UE 115 via a PDSCH according to a DL scheduling grant. The UE 115 may transmit a UL communication signal to the BS 105 via a PUSCH and/or PUCCH according to a UL scheduling grant.

The network 100 may be designed to enable a wide range of use cases. While in some examples a network 100 may utilize monolithic base stations, there are a number of other architectures which may be used to perform aspects of the present disclosure. For example, a BS 105 may be separated into a remote radio head (RRH) and baseband unit (BBU). BBUs may be centralized into a BBU pool and connected to RRHs through low-latency and high-bandwidth transport links, such as optical transport links. BBU pools may be cloud-based resources. In some aspects, baseband processing is performed on virtualized servers running in data centers rather than being co-located with a BS 105. In another example, based station functionality may be split between a remote unit (RU), distributed unit (DU), and a central unit (CU). An RU generally performs low physical layer functions while a DU performs higher layer functions, which may include higher physical layer functions. A CU performs the higher RAN functions, such as radio resource control (RRC).

For simplicity of discussion, the present disclosure refers to methods of the present disclosure being performed by base stations, or more generally network entities, while the functionality may be performed by a variety of architectures other than a monolithic base station. In addition to disaggregated base stations, aspects of the present disclosure may also be performed by a centralized unit (CU), a distributed unit (DU), a radio unit (RU), a Near-Real Time (Near-RT) RAN Intelligent Controller (RIC), a Non-Real Time (Non-RT) RIC, integrated access and backhaul (IAB) node, a relay node, a sidelink node, etc.

In some aspects, the UE 115 may transmit an indicator to the BS 105 indicating an expected outage (e.g., an expected service outage in network 100). The UE 115 may start an outage timer based on the indicator and refrain from communicating for a duration of the outage timer.

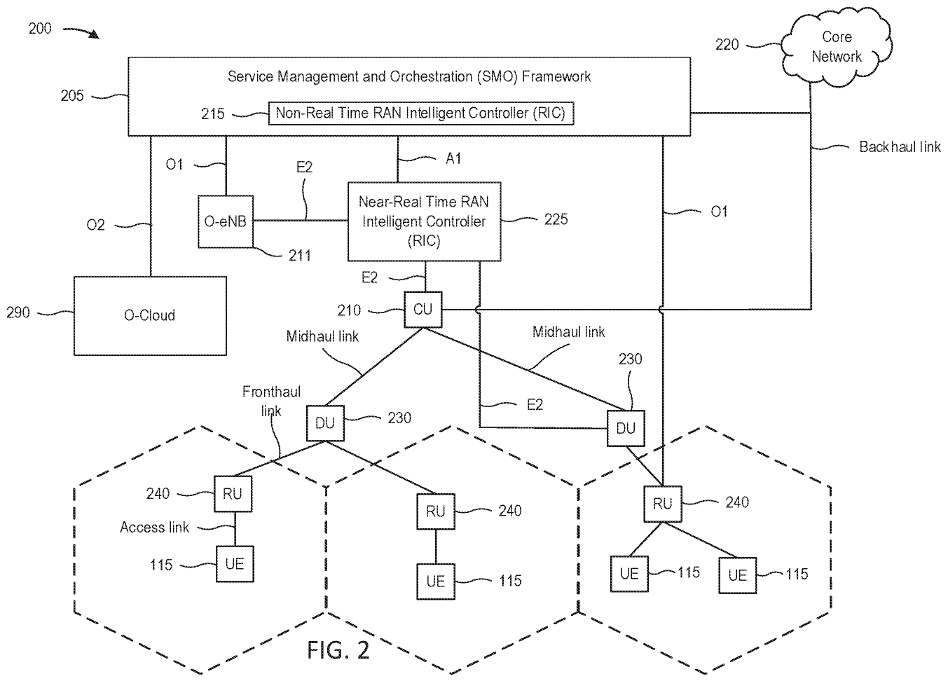

FIG. 2 shows a diagram illustrating an example disaggregated base station 200 architecture. The disaggregated base station 200 architecture may include one or more central units (CUs) 210 that can communicate directly with a core network 220 via a backhaul link, or indirectly with the core network 220 through one or more disaggregated base station units (such as a Near-Real Time (Near-RT) RAN Intelligent Controller (RIC) 225 via an E2 link, or a Non-Real Time (Non-RT) RIC 215 associated with a Service Management and Orchestration (SMO) Framework 205, or both). A CU 210 may communicate with one or more distributed units (DUs) 230 via respective midhaul links, such as an F1 interface. The DUs 230 may communicate with one or more radio units (RUs) 240 via respective fronthaul links. The RUs 240 may communicate with respective UEs 115 via one or more radio frequency (RF) access links. In some implementations, the UE 115 may be simultaneously served by multiple RUs 240.

Each of the units, i.e., the CUS 210, the DUs 230, the RUs 240, as well as the Near-RT RICs 225, the Non-RT RICs 215 and the SMO Framework 205, may include one or more interfaces or be coupled to one or more interfaces configured to receive or transmit signals, data, or information (collectively, signals) via a wired or wireless transmission medium. Each of the units, or an associated processor or controller providing instructions to the communication interfaces of the units, can be configured to communicate with one or more of the other units via the transmission medium. For example, the units can include a wired interface configured to receive or transmit signals over a wired transmission medium to one or more of the other units. Additionally, the units can include a wireless interface, which may include a receiver, a transmitter or transceiver (such as a radio frequency (RF) transceiver), configured to receive or transmit signals, or both, over a wireless transmission medium to one or more of the other units.

In some aspects, the CU 210 may host one or more higher layer control functions. Such control functions can include radio resource control (RRC), packet data convergence protocol (PDCP), service data adaptation protocol (SDAP), or the like. Each control function can be implemented with an interface configured to communicate signals with other control functions hosted by the CU 210. The CU 210 may be configured to handle user plane functionality (i.e., Central Unit-User Plane (CU-UP)), control plane functionality (i.e., Central Unit-Control Plane (CU-CP)), or a combination thereof. In some implementations, the CU 210 can be logically split into one or more CU-UP units and one or more CU-CP units. The CU-UP unit can communicate bidirectionally with the CU-CP unit via an interface, such as the E1 interface when implemented in an O-RAN configuration. The CU 210 can be implemented to communicate with the DU 230, as necessary, for network control and signaling.

The DU 230 may correspond to a logical unit that includes one or more base station functions to control the operation of one or more RUs 240. In some aspects, the DU 230 may host one or more of a radio link control (RLC) layer, a medium access control (MAC) layer, and one or more high physical (PHY) layers (such as modules for forward error correction (FEC) encoding and decoding, scrambling, modulation and demodulation, or the like) depending, at least in part, on a functional split, such as those defined by the 3^{rd} Generation Partnership Project (3GPP). In some aspects, the DU 230 may further host one or more low PHY layers. Each layer (or module) can be implemented with an interface configured to communicate signals with other layers (and modules) hosted by the DU 230, or with the control functions hosted by the CU 210.

Lower-layer functionality can be implemented by one or more RUs 240. In some deployments, an RU 240, controlled by a DU 230, may correspond to a logical node that hosts RF processing functions, or low-PHY layer functions (such as performing fast Fourier transform (FFT), inverse FFT (iFFT), digital beamforming, physical random access channel (PRACH) extraction and filtering, or the like), or both, based at least in part on the functional split, such as a lower layer functional split. In such an architecture, the RU(s) 240 can be implemented to handle over the air (OTA) communication with one or more UEs 115. In some implementations, real-time and non-real-time aspects of control and user plane communication with the RU(s) 240 can be controlled by the corresponding DU 230. In some scenarios, this configuration can enable the DU(s) 230 and the CU 210 to be implemented in a cloud-based RAN architecture, such as a vRAN architecture.

The SMO Framework 205 may be configured to support RAN deployment and provisioning of non-virtualized and virtualized network elements. For non-virtualized network elements, the SMO Framework 205 may be configured to support the deployment of dedicated physical resources for RAN coverage requirements which may be managed via an operations and maintenance interface (such as an O1 interface). For virtualized network elements, the SMO Framework 205 may be configured to interact with a cloud computing platform (such as an open cloud (O-Cloud) 290) to perform network element life cycle management (such as to instantiate virtualized network elements) via a cloud computing platform interface (such as an O2 interface). Such virtualized network elements can include, but are not limited to, CUs 210, DUs 230, RUs 240 and Near-RT RICs 225. In some implementations, the SMO Framework 205 can communicate with a hardware aspect of a 4G RAN, such as an open eNB (O-eNB) 211, via an O1 interface. Additionally, in some implementations, the SMO Framework 205 can communicate directly with one or more RUs 240 via an O1 interface. The SMO Framework 205 also may include a Non-RT RIC 215 configured to support functionality of the SMO Framework 205.

The Non-RT RIC 215 may be configured to include a logical function that enables non-real-time control and optimization of RAN elements and resources, Artificial Intelligence/Machine Learning (AI/ML) workflows including model training and updates, or policy-based guidance of applications/features in the Near-RT RIC 225. The Non-RT RIC 215 may be coupled to or communicate with (such as via an A1 interface) the Near-RT RIC 225. The Near-RT RIC 225 may be configured to include a logical function that enables near-real-time control and optimization of RAN elements and resources via data collection and actions over an interface (such as via an E2 interface) connecting one or more CUs 210, one or more DUs 230, or both, as well as an O-eNB, with the Near-RT RIC 225.

In some implementations, to generate AI/ML models to be deployed in the Near-RT RIC 225, the Non-RT RIC 215 may receive parameters or external enrichment information from external servers. Such information may be utilized by the Near-RT RIC 225 and may be received at the SMO Framework 205 or the Non-RT RIC 215 from non-network data sources or from network functions. In some examples, the Non-RT RIC 215 or the Near-RT RIC 225 may be configured to tune RAN behavior or performance. For example, the Non-RT RIC 215 may monitor long-term trends and patterns for performance and employ AI/ML models to perform corrective actions through the SMO Framework 205 (such as reconfiguration via O1) or via creation of RAN management policies (such as A1 policies).

In some aspects, the RU 240 may receive an indicator from the UE 115 indicating an expected outage (e.g., an expected service outage in network 200). The RU 240 and/or DU 230 may start an outage timer based on the indicator and refrain from communicating with the UE 115 for a duration of the outage timer.

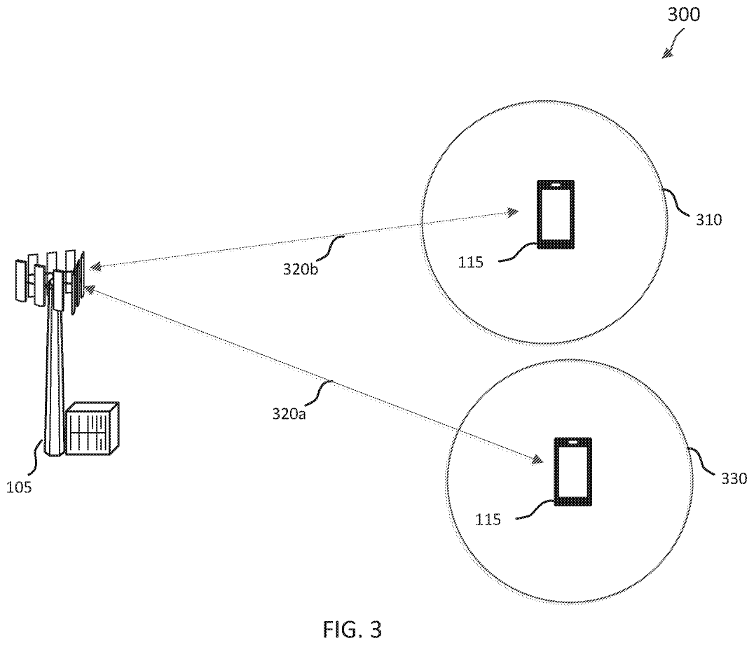

FIG. 3 illustrates a service outage area in a wireless communication network 300 according to some aspects of the present disclosure. Communication network 300 may include communication network 100 and/or communication network 200. In some aspects, the UE 115 may be located in an area 330 where communication link 320a between the network unit 105 and the UE 115 may provide communication services to the UE 115. In some aspects, the UE 115 may be a mobile UE and move to an area 310 where communication link 320b between the network unit 105 and the UE 115 may not provide communication services to the UE 115. The area 310 may be a network outage area where network services are unreliable and/or not available.

In some aspects, the UE 115 may transmit an indicator to the network unit 105 indicating an expected outage in area 310. The UE 115 may transmit the indicator to the network unit 105 over communication link 320a while the UE 115 is in area 330 having network coverage. In this regard, the UE 115 may transmit the indicator via at least one of a radio resource control (RRC) message, a medium access control control element (MAC-CE) communication, or other suitable communication. For example, the MAC-CE may include codepoint(s) indicating the expected outage, a duration of the expected outage, a type of call (e.g., normal or emergency) prior to entering the outage area 310, and/or other suitable parameters associated with the expected outage. In some aspects, the UE 115 may transmit the indicator via a UEAssistanceInformation information element. For example, the UEAssistanceInformation information element may include codepoint(s) indicating the expected outage, a duration of the expected outage, a type of call (e.g., normal or emergency) prior to entering the outage and/or other suitable parameters associated with the expected outage area 310. The outage may include a communication network outage (e.g., an outage of the communication network 100, 200, or 300). For example, the UE 115 may enter a geographic area (e.g., geographic area 310) or other location that does not have network coverage (e.g., a service outage) and/or sufficient coverage to continue an existing communication session. For example, the UE 115 may enter an elevator lift, a building, an outdoor area, or other location in which the UE does not have network service. In some aspects, the outage may be a reduced service outage. For example, when the UE 115 is in certain locations, the network service may be unable to provide sufficient resources for a current or scheduled session. The session(s) may require certain parameters (e.g., latency, bandwidth, block error rate, etc.) of the network service to satisfy a minimum quality of service. A reduced service outage may be unable to satisfy the minimum quality of service for the session(s). In some aspects, the UE 115 may operate using mm Wave communications and directional beams. In this case, the UE 115 may experience more frequent outages as compared to the UE 115 using lower frequency, non mmWave communications. Aspects of the present disclosure may provide methods of reducing UE 115 power consumption during the outage by placing the UE 115 in a low power mode for the duration of the outage.

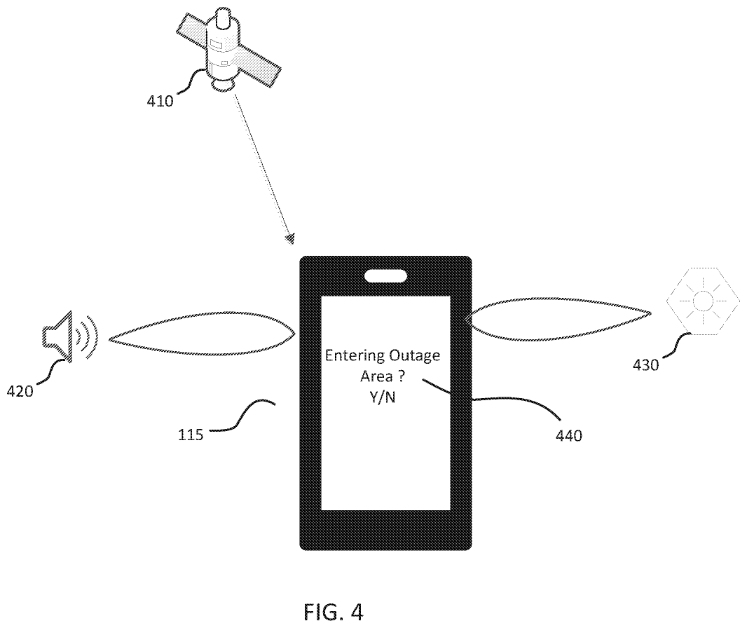

FIG. 4 illustrates location determination methods associated with the UE 115 according to some aspects of the present disclosure. In some aspects, the UE 115 may determine the expected network outage or reduced service outage based on sensor inputs. For example, the UE 115 may include one or more sensors (e.g., light sensors, acoustic sensors, RF sensors, location sensors, etc.) that provide measurements to the UE 115. The UE 115 may determine, based on the measurements, that the UE 115 is expected to enter, or is in, an area (e.g., area 310) without network coverage and experience the outage. In some aspects, the UE 115 may store locations (e.g., area 310) associated with known outages and reduced service outages (e.g., based on experiencing one or more previous outages in the location(s)). The UE 115 may expect to experience an outage when re-entering those locations. The UE 115 may compare its current location and/or expected future location based on the UEs speed and direction to the known outage locations to determine if an outage is expected. In some aspects, the UE 115 may determine its location based on GPS signals, RF triangulation, sensor input(s), and/or other suitable location determining method(s). For example, the UE may determine its location based on receiving GPS signals from multiple GPS satellites 410. In some aspects, the UE 115 may sense sound inputs from sound source 420 and determine its location based on a sound signature associated with the sound source 420. In some aspects, the UE 115 may sense light inputs from light source 430 and determine its location based on a light signature associated with the light source 430. In some aspects, the UE 115 may use a combination of sensor inputs to determine its location.

In some aspects, the UE 115 may determine an expected outage based on input from a user of the UE 115. For example, the user of the UE 115 may have knowledge of entering an expected outage area (e.g., area 310). The user may enter an input to the UE 115 (e.g., via a user interface, including inputs via software and/or hardware) indicating the expected outage. For example, the user may use user interface 440 to input an outage area to the UE 115.

In some aspects, the indicator indicating the expected outage or reduced service outage may further indicate a duration of the expected outage. The duration of the expected outage may include a time span during which the UE 115 is expected to be without network coverage or have reduced network coverage. For example, the UE 115 may determine the duration of the expected outage based on previous outages at certain locations, UE 115 mobility, and/or other factors. For example, the UE 115 may store locations and outage durations associated with past outages. When the UE 115 approaches and/or enters an outage location, the UE 115 may determine the outage duration (e.g., an estimated outage duration) based on the previously stored outage durations.

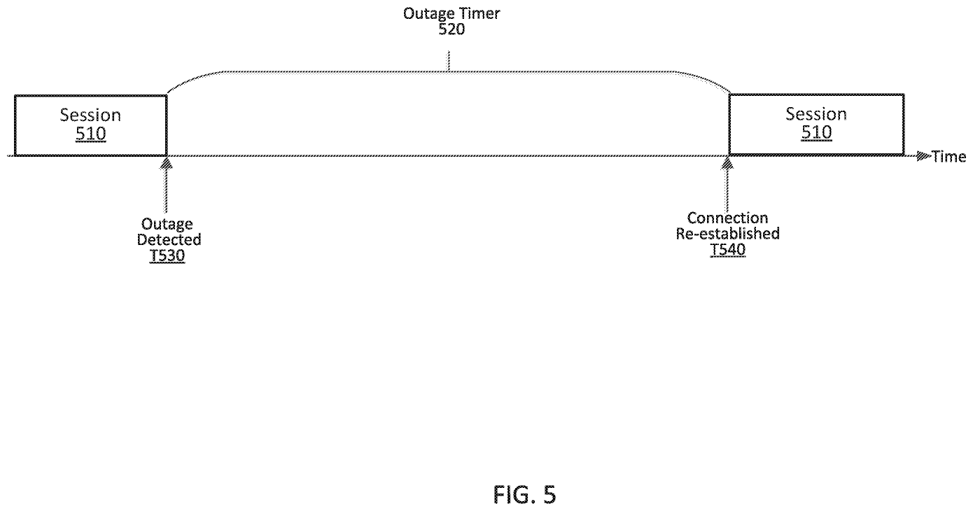

FIG. 5 illustrates a call continuity timeline in a wireless communication network (e.g., communication network 100, 200, or 300) according to some aspects of the present disclosure. In some aspects, the UE 115 may start an outage timer 520 when entering an outage area (e.g., outage area 310). The outage timer 520 may be based on an outage duration (e.g., the expected time in which the UE 115 expects to experience the network service outage or reduced service outage). In some aspects, the UE 115 may enter a low power mode (e.g., a sleep mode) for the duration of the outage timer 520. In this way, the UE 115 may conserve battery power for the duration of the outage. The UE 115 may determine that certain components of the UE 115 may enter the low power mode and certain components may not enter a low power mode (e.g., continue operating in a connected state and/or full power mode). For example, a processor (e.g., processor 802), a memory (e.g., memory 804), and a transceiver (e.g., transceiver 810) may enter a low power mode while other components of the UE 115 (e.g., application processor, display, WiFi modem, etc.) may not enter a low power mode.

In some aspects, the UE 115 may store (e.g., store in memory 804), a context associated with the UE 115 prior to entering the low power mode. In this way, in some instances the UE 115 may restore the context when waking up from the low power mode. The context may include information associated with one or more sessions 510 active when the outage is expected. For example, if the UE 115 was transmitting content to a network unit when the outage was expected, the UE 115 may store information indicating the portion of the content remaining to be transmitted to the network unit when the UE 115 wakes up from low power mode and network service is restored. The context information stored before the UE 115 enters the low power mode may include processor (e.g., processor 802) register contents, cache memory contents, pointers, bookmarks, process states, operating system kernel states, transceiver (e.g., transceiver 810) configurations. After the UE 115 wakes up from low power mode, the context information may be restored.

In some aspects, the UE 115 may refrain from communicating for a duration of the outage timer 520. In this regard, the UE 115 may refrain from transmitting for the duration of the outage timer 520. Additionally or alternatively, the UE 115 may refrain from monitoring for a communication from the network unit for the duration of the outage timer 520. The UE 115 may refrain from communicating for a duration of the outage timer 520 based on the UE 115 entering a low power mode during the outage. The UE 115 may enter the lower power mode to conserve battery power for the duration of the expected outage.

In some aspects, the network unit may refrain from communicating with the UE for a duration of the outage timer 520. In this regard, the network unit may refrain from transmitting for the duration of the outage timer 520. Additionally or alternatively, the network unit may refrain from monitoring for a communication from the UE for the duration of the outage timer 520. The network unit may refrain from allocating resources (e.g., time resources, frequency resources) to the UE during for the duration of the outage timer. In some aspects, the network unit may reallocate resources that were allocated to the UE to other UE(s) for the duration of the outage timer thereby conserving network resources and increasing network capacity.

In some aspects, the UE 115 may establish a session 510 (e.g., a data session, a voice session) with the network unit prior to the expected outage. The UE 115 may pause the session 510 during the outage by storing the session 510 context prior to entering low power mode when the outage is detected at T530 and then restoring the session 510 at T540 upon expiration of the outage timer 520. In some instances, the UE 115 may restore the session 510 by resuming communication with the network unit upon expiration of the outage timer 520. In some aspects, the UE 115 may perform a cell search and/or beam recovery procedure to resume communicating with the network unit. Upon reestablishing a connection (e.g., RRC connected mode) with the network unit, the UE 115 may restore the session 510 context and continue the session 510. In some aspects, the session 510 may include a voice call. When the voice call is paused due to the service outage, the UE 115 may transmit the indicator to the network unit further indicating a request for the network unit to transmit a call “on hold” message to other UE 115(s) and/or devices engaged in the voice call. In this way, a user of the other UE 115(s) and/or devices may know the voice session has been placed on hold (e.g., paused). In some aspects, the “on hold” message may include an indicator indicating the expected hold time based on the outage timer 520. After the UE 115 reestablishes the connection and the voice session with the network unit at time T540, the network unit may transmit a “call resumed”message to the other UE 115(s).

In some aspects, the UE 115 may establish communication with a different network unit (e.g., a second network unit) upon expiration of the outage timer 520. For example, when the outage timer 520 expires, the UE 115 may no longer be in the coverage area of the network unit (e.g., a first network unit) that the UE 115 was previously communicating with and the UE 115 may be in a coverage area of the second network unit (e.g., different than the first network unit). The UE 115 may establish a connection with the second network unit and restore the session 510 through the second network unit. In this regard, the UE 115 may transmit a request to the second network unit for restoring the session 510. In some aspects, the UE 115 may transmit an indicator to the second network unit indicating an identifier of the first network unit.

The second network unit may transmit a request to the first network unit requesting the context associated with the session 510 that was stored by the first network unit prior to pausing the session 510. The second network unit may receive the session context from the first network unit and restore (e.g., resume) the session 510 with the UE 115.

In some aspects, the UE 115 may determine that it has entered an area having network coverage prior to expiration of the outage timer 520. In this regard, the UE 115 may determine it has entered an area having network coverage based on the UE 115 location. Additionally or alternatively, the UE 115 may periodically wake up from the low power state to check whether the UE 115 has network coverage. For example, the UE 115 may monitor for a PSS and SSS to acquire slot synchronization with the network unit and to identify the cell number associated with the network. In some aspects, the UE 115 may monitor for demodulation reference signal(s) to determine the signal quality (e.g., RSRP) in the cell. The UE 115 may decode information on the broadcast channel (BCH) and decode the master information block (MIB) to acquire details about the cell. The UE 115 may monitor for network coverage at a longer periodicity when the UE 115 is in a low power mode as compared to the network monitoring periodicity when the UE 115 is not in a low power mode.

When the UE 115 determines that it has entered an area having network coverage prior to expiration of the outage timer 520, the UE 115 may reestablish a connection (e.g., RRC connected mode) with the network unit at time T540 and transmit an indicator to the network unit cancelling the expected outage indicator. The UE 115 may reestablish the connection with the network unit using a cell recovery procedure and/or a beam recovery procedure.

In some aspects, the UE 115 may establish communication with a different network unit (e.g., a second network unit) prior to expiration of the outage timer 520. For example, before the outage timer 520 expires, the UE 115 may no longer be in the coverage area of the network unit (e.g., a first network unit) that the UE 115 was previously communicating with and the UE 115 may be in a coverage area of the second network unit (e.g., different than the first network unit). The UE 115 may establish a connection with the second network unit and restore the session 510 through the second network unit.

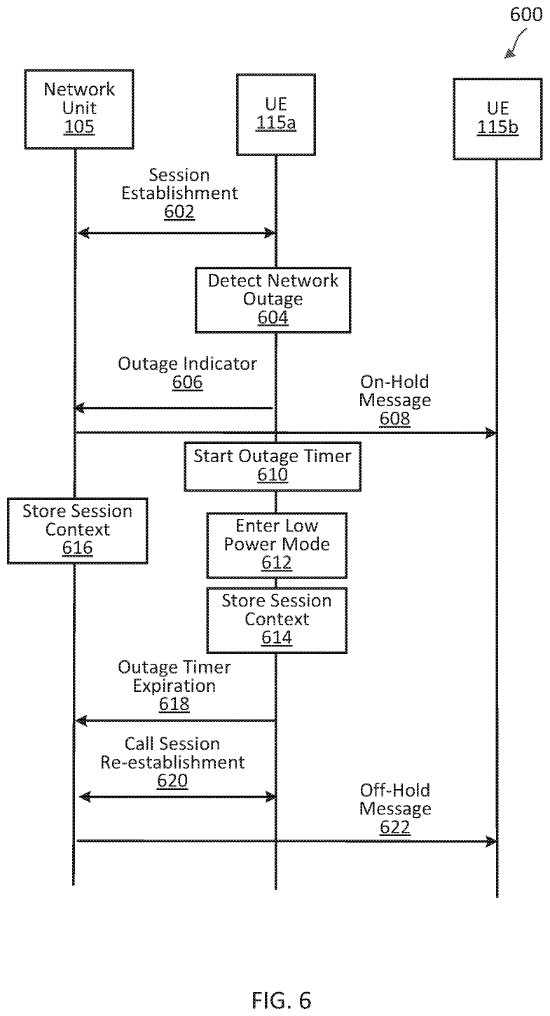

FIG. 6 is a flow diagram of a communication method 600 according to some aspects of the present disclosure. Aspects of the method 600 can be executed by a computing device (e.g., a processor, processing circuit, and/or other suitable component) of a wireless communication device or other suitable means for performing the actions. For example, a wireless communication device, such as the BS 105, the RU 240, the DU 230, the CU 210, and/or the network unit 900, may utilize one or more components, such as the processor 902, the memory 904, the outage detection module 908, the transceiver 910, the modem 912, and the one or more antennas 916, to execute aspects of method 600. For example, a wireless communication device, such as the UE 115 or the UE 800 may utilize one or more components, such as the processor 802, the memory 804, the network outage module 808, the transceiver 810, the modem 812, and the one or more antennas 816, to execute aspects of method 600. The method 600 may employ similar mechanisms as in the networks 100, 200, or 300 and the aspects and actions described with respect to FIGS. 3-5. As illustrated, the method 600 includes a number of enumerated actions, but the method 600 may include additional actions before, after, and in between the enumerated actions. In some aspects, one or more of the enumerated actions may be omitted or performed in a different order.

At action 602, the network unit 105 may establish a session (e.g., a voice session, a data session) with the UE 115a.

At action 604, the UE 115a may detect that the UE 115a is entering a service outage area. In some aspects, the UE 115a may detect the expected network outage or reduced service outage based on sensor inputs. For example, the UE115a may include one or more sensors (e.g., light sensors, acoustic sensors, RF sensors, location sensors, etc.) that provide measurements to the UE 115a. The UE 115a may determine, based on the measurements, that the UE 115a is expected to enter, or is in, an area without network coverage and experience the outage. In some aspects, the UE 115a may store locations associated with known outages and reduced service outages (e.g., based on experiencing one or more previous outages in the location(s)). The UE 115a may expect to experience an outage when re-entering those locations. The UE 115a may compare its current location and/or expected future location based on the UEs speed and direction to the known outage locations to determine if an outage is expected. In some aspect, the UE115a may determine its location based on GPS signals, RF triangulation, or other suitable location determining method(s). In some aspects, the UE may detect an expected outage based on input from a user of the UE 115. For example, the user of the UE 115a may have knowledge of entering an expected outage area. The user may enter an input to the UE 115a (e.g., via a user interface, including inputs via software and/or hardware) indicating the expected outage.

At action 606, the UE 115a may transmit an indicator to the network unit 105 indicating an expected outage. In this regard, the UE may transmit the indicator via at least one of a radio resource control (RRC) message, a medium access control control element (MAC-CE) communication, or other suitable communication. For example, the MAC-CE may include codepoint(s) indicating the expected outage, a duration of the expected outage, a type of call (e.g., normal or emergency) prior to entering the outage, and/or other suitable parameters associated with the expected outage. In some aspects, the UE 115a may transmit the indicator via a UEAssistanceInformation information element. For example, the UEAssistanceInformation information element may include codepoint(s) indicating the expected outage, a duration of the expected outage, a type of call (e.g., normal or emergency) prior to entering the outage and/or other suitable parameters associated with the expected outage.

At action 608, the network unit 105 may pause the session and transmit a call “on hold” message to the UE 115b and other UE(s) and/or devices engaged in the voice call. In this way, a user of the UE 115b may know the voice session has been placed on hold (e.g., paused). In some aspects, the “on hold” message may include an indicator indicating the expected hold time based on the outage timer.

At action 610, the UE 115a may start an outage timer. The outage timer may be based on an outage duration (e.g., the expected time in which the UE 115a expects to experience the network service outage or reduced service outage).

At action 612, the UE 115a may enter a low power mode (e.g., a sleep mode) for the duration of the outage timer. In this way, the UE 115a may conserve battery power for the duration of the outage. The UE115a may determine that certain components of the UE115a may enter the low power mode and certain components may not enter a low power mode (e.g., continue operating in a connected state and/or full power mode). For example, a processor (e.g., processor 802), a memory (e.g., memory 804), and a transceiver (e.g., transceiver 810) may enter a low power mode while other components of the UE 115a (e.g., application processor, display, WiFi modem, etc.) may not enter a low power mode.

At action 614, the UE 115a may store the session context. In some aspects, the UE 115a may store (e.g., store in memory 804), a context associated with the UE 115a prior to entering the low power mode. In this way, in some instances the UE 115a may restore the context when waking up from the low power mode. The context may include information associated with one or more sessions active when the outage is expected. For example, if the network unit was receiving content from the UE 115 when the outage was expected, the UE 115a may store information indicating the portion of the content remaining to be transmitted to the network unit when the UE wakes up from low power mode and network service is restored. The context information stored before the UE 115a enters the low power mode may include processor (e.g., processor 802) register contents, cache memory contents, pointers, bookmarks, process states, operating system kernel states, transceiver (e.g., transceiver 810) configurations. After the UE wakes up from low power mode, the context information may be restored.

At action 616, the network unit 105 may store the session context. In some aspects, the network unit 105 may store (e.g., store in memory 904), a context associated with a session of the UE 115a. In this way, the network unit 105 may restore the context when reestablishing the session with the UE 115a. The context may include information associated with one or more sessions active when the outage is expected. For example, if the network unit was receiving content from the UE 115 when the outage was expected, the network unit 105 may store information indicating the portion of the content remaining to be transmitted to the network unit when the UE wakes up from low power mode and network service is restored. The context information stored may include processor (e.g., processor 902) register contents, cache memory contents, pointers, bookmarks, process states, operating system kernel states, transceiver (e.g., transceiver 910) configurations.

At action 618, the UE 115a may transmit an indicator indicating expiration of the outage timer. The UE 115a may pause the session during the outage by storing the session context prior to entering low power mode and then restoring the session upon expiration of the outage timer.

At action 620, the UE 115a and network unit 105 may reestablish a connection and resume the session. In some instances, the UE 115a may restore the session by resuming communication with the network unit 105 upon expiration of the outage timer. In some aspects, the UE 115a may perform a cell search and/or beam recovery procedure to resume communicating with the network unit 105. Upon reestablishing a connection (e.g., RRC connected mode) with the network unit 105, the UE 115a may restore the session context and continue the session.

At action 622, the network unit 105 may transmit an “off hold” message to the UE 115b. After the UE reestablishes the connection with the network unit 105 at action 620 and resumes the session (e.g., voice session) with the network unit 105, the network unit 105 may transmit an “off hold” message or “call resumed” message to the UE 115b.

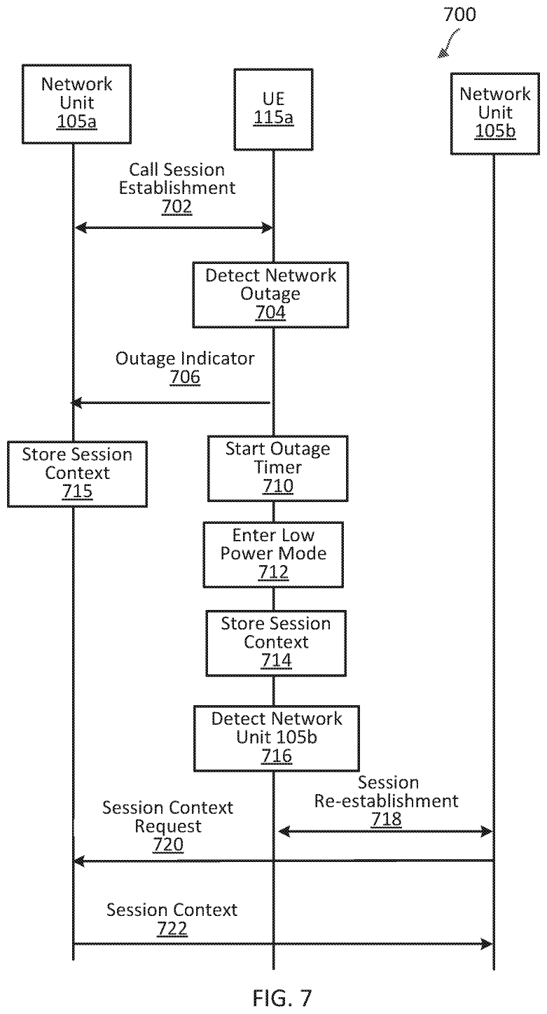

FIG. 7 is a flow diagram of a communication method 700 according to some aspects of the present disclosure. Aspects of the method 700 can be executed by a computing device (e.g., a processor, processing circuit, and/or other suitable component) of a wireless communication device or other suitable means for performing the actions. For example, a wireless communication device, such as the BS 105, the RU 240, the DU 230, the CU 210, and/or the network unit 900, may utilize one or more components, such as the processor 902, the memory 904, the outage detection module 908, the transceiver 910, the modem 912, and the one or more antennas 916, to execute aspects of method 600. For example, a wireless communication device, such as the UE 115 or the UE 800 may utilize one or more components, such as the processor 802, the memory 804, the network outage module 808, the transceiver 810, the modem 812, and the one or more antennas 816, to execute aspects of method 700. The method 700 may employ similar mechanisms as in the networks 100, 200, or 300 and the aspects and actions described with respect to FIGS. 3-5. As illustrated, the method 700 includes a number of enumerated actions, but the method 700 may include additional actions before, after, and in between the enumerated actions. In some aspects, one or more of the enumerated actions may be omitted or performed in a different order.

At action 702, the network unit 105a may establish a session (e.g., a voice session, a data session) with the UE 115a.

At action 704, the UE 115a may detect that the UE 115a is entering a service outage area. In some aspects, the UE 115a may detect the expected network outage or reduced service outage based on sensor inputs. For example, the UE115a may include one or more sensors (e.g., light sensors, acoustic sensors, RF sensors, location sensors, etc.) that provide measurements to the UE 115a. The UE 115a may determine, based on the measurements, that the UE 115a is expected to enter, or is in, an area without network coverage and experience the outage. In some aspects, the UE 115a may store locations associated with known outages and reduced service outages (e.g., based on experiencing one or more previous outages in the location(s)). The UE 115a may expect to experience an outage when re-entering those locations. The UE 115a may compare its current location and/or expected future location based on the UEs speed and direction to the known outage locations to determine if an outage is expected. In some aspect, the UE115a may determine its location based on GPS signals, RF triangulation, or other suitable location determining method(s). In some aspects, the UE may detect an expected outage based on input from a user of the UE 115. For example, the user of the UE 115a may have knowledge of entering an expected outage area. The user may enter an input to the UE 115a (e.g., via a user interface, including inputs via software and/or hardware) indicating the expected outage.

At action 706, the UE 115a may transmit an indicator to the network unit 105a indicating an expected outage. In this regard, the UE may transmit the indicator via at least one of a radio resource control (RRC) message, a medium access control control element (MAC-CE) communication, or other suitable communication. For example, the MAC-CE may include codepoint(s) indicating the expected outage, a duration of the expected outage, a type of call (e.g., normal or emergency) prior to entering the outage, and/or other suitable parameters associated with the expected outage. In some aspects, the UE 115a may transmit the indicator via a UEAssistanceInformation information element. For example, the UEAssistanceInformation information element may include codepoint(s) indicating the expected outage, a duration of the expected outage, a type of call (e.g., normal or emergency) prior to entering the outage and/or other suitable parameters associated with the expected outage.

At action 710, the UE 115a may start an outage timer. The outage timer may be based on an outage duration (e.g., the expected time in which the UE 115a expects to experience the network service outage or reduced service outage).

At action 712, the UE 115a may enter a low power mode (e.g., a sleep mode) for the duration of the outage timer. In this way, the UE 115a may conserve battery power for the duration of the outage. The UE115a may determine that certain components of the UE115a may enter the low power mode and certain components may not enter a low power mode (e.g., continue operating in a connected state and/or full power mode). For example, a processor (e.g., processor 802), a memory (e.g., memory 804), and a transceiver (e.g., transceiver 810) may enter a low power mode while other components of the UE 115a (e.g., application processor, display, WiFi modem, etc.) may not enter a low power mode.

At action 714, the UE 115a may store the session context. In some aspects, the UE 115a may store (e.g., store in memory 804), a context associated with the UE 115a prior to entering the low power mode. In this way, in some instances the UE 115a may restore the context when waking up from the low power mode. The context may include information associated with one or more sessions active when the outage is expected.

For example, if the network unit was receiving content from the UE 115 when the outage was expected, the UE 115a may store information indicating the portion of the content remaining to be transmitted to the network unit when the UE wakes up from low power mode and network service is restored. The context information stored before the UE 115a enters the low power mode may include processor (e.g., processor 802) register contents, cache memory contents, pointers, bookmarks, process states, operating system kernel states, transceiver (e.g., transceiver 810) configurations. After the UE wakes up from low power mode, the context information may be restored.

At action 715, the network unit 105 may store the session context. In some aspects, the network unit 105 may store (e.g., store in memory 904), a context associated with a session of the UE 115a. In this way, in some instances the network unit 105 may restore the context when reestablishing the session with the UE 115a. The context may include information associated with one or more sessions active when the outage is expected. For example, if the network unit was receiving content from the UE 115 when the outage was expected, the network unit 105 may store information indicating the portion of the content remaining to be transmitted to the network unit when the UE wakes up from low power mode and network service is restored. The context information stored may include processor (e.g., processor 902) register contents, cache memory contents, pointers, bookmarks, process states, operating system kernel states, transceiver (e.g., transceiver 910) configurations.

At action 716, the UE 115a may detect network unit 105b. The UE 115a may detect network unit 105b prior to or upon expiration of the outage timer. The UE 115 may detect the network unit 105b based on a cell search.

At action 718, the UE 115a and the network unit 105b may establish communication. For example, when the outage timer expires, the UE 115 may no longer be in the coverage area of the network unit 105a that the UE 115 was previously communicating with and the UE 115 may be in a coverage area of the network unit 105b (e.g., different than the network unit 105a). The UE 115 may establish a connection with the network unit 105b and restore the session through the network unit 105b. In this regard, the UE 115 may transmit a request to the network unit 105b for restoring the session. In some aspects, the UE 115 may transmit an indicator to the network unit 105b indicating an identifier of the network unit 105a.

At action 720, the network unit 105b may transmit a request to the network unit 105a requesting the context associated with the session that was stored by the network unit 105a at action 715 prior to pausing the session.

At action 722, the network unit 105a may transmit the session context to the network unit 105b. The network unit 105b may receive the session context from the network unit 105a and restore (e.g., resume) the session with the UE 115.

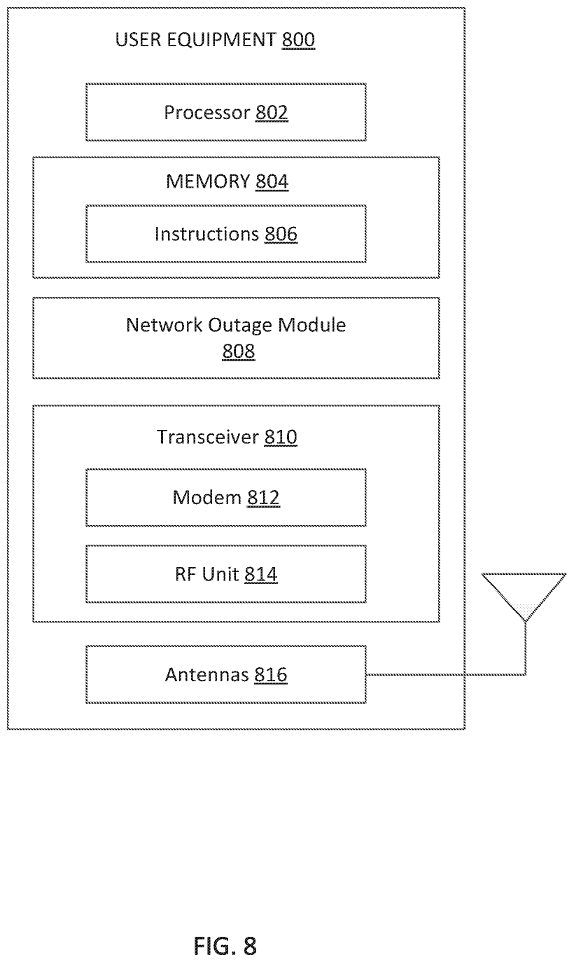

FIG. 8 is a block diagram of an exemplary UE 800 according to some aspects of the present disclosure. The UE 800 may be the UE 115 in the network 100, or 200 as discussed above. As shown, the UE 800 may include a processor 802, a memory 804, a network outage module 808, a transceiver 810 including a modem subsystem 812 and a radio frequency (RF) unit 814, and one or more antennas 816. These elements may be coupled with each other and in direct or indirect communication with each other, for example via one or more buses.

The processor 802 may include a central processing unit (CPU), a digital signal processor (DSP), an application specific integrated circuit (ASIC), a controller, a field programmable gate array (FPGA) device, another hardware device, a firmware device, or any combination thereof configured to perform the operations described herein. The processor 802 may also be implemented as a combination of computing devices, e.g., a combination of a DSP and a microprocessor, a plurality of microprocessors, one or more microprocessors in conjunction with a DSP core, or any other such configuration.

The memory 804 may include a cache memory (e.g., a cache memory of the processor 802), random access memory (RAM), magnetoresistive RAM (MRAM), read-only memory (ROM), programmable read-only memory (PROM), erasable programmable read only memory (EPROM), electrically erasable programmable read only memory (EEPROM), flash memory, solid state memory device, hard disk drives, other forms of volatile and non-volatile memory, or a combination of different types of memory. In some instances, the memory 804 includes a non-transitory computer-readable medium. The memory 804 may store instructions 806. The instructions 806 may include instructions that, when executed by the processor 802, cause the processor 802 to perform the operations described herein with reference to the UEs 115 in connection with aspects of the present disclosure, for example, aspects of FIGS. 3-7. Instructions 806 may also be referred to as code. The terms “instructions” and “code” should be interpreted broadly to include any type of computer-readable statement(s). For example, the terms “instructions” and “code” may refer to one or more programs, routines, sub-routines, functions, procedures, etc. “Instructions” and “code” may include a single computer-readable statement or many computer-readable statements.

The network outage module 808 may be implemented via hardware, software, or combinations thereof. For example, the network outage module 808 may be implemented as a processor, circuit, and/or instructions 806 stored in the memory 804 and executed by the processor 802. In some aspects, the network outage module 808 may implement the aspects of FIGS. 3-7. For example, the network outage module 808 may transmit, to a network unit, an indicator indicating an expected outage, the network outage module 808 may start an outage timer based on the indicator and refrain from communicating for a duration of the outage timer.

As shown, the transceiver 810 may include the modem subsystem 812 and the RF unit 814. The transceiver 810 can be configured to communicate bi-directionally with other devices, such as the BSs 105 and/or the UEs 115. The modem subsystem 812 may be configured to modulate and/or encode the data from the memory 804 and the according to a modulation and coding scheme (MCS), e.g., a low-density parity check (LDPC) coding scheme, a turbo coding scheme, a convolutional coding scheme, a digital beamforming scheme, etc. The RF unit 814 may be configured to process (e.g., perform analog to digital conversion or digital to analog conversion, etc.) modulated/encoded data from the modem subsystem 812 (on outbound transmissions) or of transmissions originating from another source such as a UE 115 or a BS 105. The RF unit 814 may be further configured to perform analog beamforming in conjunction with the digital beamforming. Although shown as integrated together in transceiver 810, the modem subsystem 812 and the RF unit 814 may be separate devices that are coupled together to enable the UE 800 to communicate with other devices.

The RF unit 814 may provide the modulated and/or processed data, e.g. data packets (or, more generally, data messages that may contain one or more data packets and other information), to the antennas 816 for transmission to one or more other devices. The antennas 816 may further receive data messages transmitted from other devices. The antennas 816 may provide the received data messages for processing and/or demodulation at the transceiver 810. The antennas 816 may include multiple antennas of similar or different designs in order to sustain multiple transmission links. The RF unit 814 may configure the antennas 816.

In some instances, the UE 800 can include multiple transceivers 810 implementing different RATs (e.g., NR and LTE). In some instances, the UE 800 can include a single transceiver 810 implementing multiple RATs (e.g., NR and LTE). In some instances, the transceiver 810 can include various components, where different combinations of components can implement RATs.

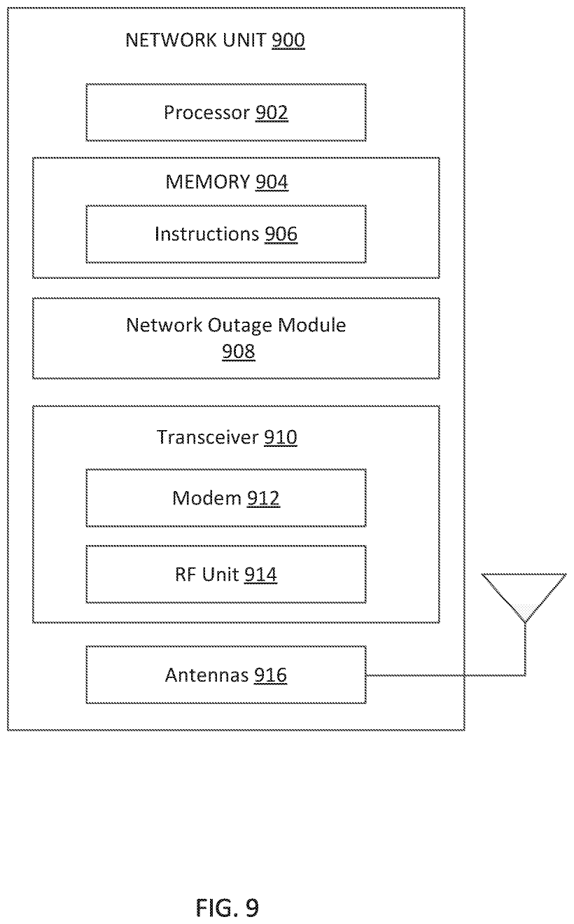

FIG. 9 is a block diagram of an exemplary network unit 900 according to some aspects of the present disclosure. The network unit 900 may be the BS 105, the CU 210, the DU 230, or the RU 240, as discussed above. As shown, the network unit 900 may include a processor 902, a memory 904, a network outage module 908, a transceiver 910 including a modem subsystem 912 and a RF unit 914, and one or more antennas 916. These elements may be coupled with each other and in direct or indirect communication with each other, for example via one or more buses.

The processor 902 may have various features as a specific-type processor. For example, these may include a CPU, a DSP, an ASIC, a controller, a FPGA device, another hardware device, a firmware device, or any combination thereof configured to perform the operations described herein. The processor 902 may also be implemented as a combination of computing devices, e.g., a combination of a DSP and a microprocessor, a plurality of microprocessors, one or more microprocessors in conjunction with a DSP core, or any other such configuration.

The memory 904 may include a cache memory (e.g., a cache memory of the processor 902), RAM, MRAM, ROM, PROM, EPROM, EEPROM, flash memory, a solid state memory device, one or more hard disk drives, memristor-based arrays, other forms of volatile and non-volatile memory, or a combination of different types of memory. In some instances, the memory 904 may include a non-transitory computer-readable medium. The memory 904 may store instructions 906. The instructions 906 may include instructions that, when executed by the processor 902, cause the processor 902 to perform operations described herein, for example, aspects of FIGS. 3-7. Instructions 906 may also be referred to as code, which may be interpreted broadly to include any type of computer-readable statement(s).

The network outage module 908 may be implemented via hardware, software, or combinations thereof. For example, the network outage module 908 may be implemented as a processor, circuit, and/or instructions 906 stored in the memory 904 and executed by the processor 902.

In some aspects, the network outage module 908 may implement the aspects of FIGS. 3-7. For example, the network outage module 808 may receive, from a UE, an indicator indicating an expected outage. The network outage module 808 may start an outage timer based on the indicator and refrain from communicating with the UE for a duration of the outage timer.

Additionally or alternatively, the network outage module 908 can be implemented in any combination of hardware and software, and may, in some implementations, involve, for example, processor 902, memory 904, instructions 906, transceiver 910, and/or modem 912.

As shown, the transceiver 910 may include the modem subsystem 912 and the RF unit 914. The transceiver 910 can be configured to communicate bi-directionally with other devices, such as the UEs 115 and/or 800. The modem subsystem 912 may be configured to modulate and/or encode data according to a MCS, e.g., a LDPC coding scheme, a turbo coding scheme, a convolutional coding scheme, a digital beamforming scheme, etc. The RF unit 914 may be configured to process (e.g., perform analog to digital conversion or digital to analog conversion, etc.) modulated/encoded data from the modem subsystem 912 (on outbound transmissions) or of transmissions originating from another source such as a UE 115 or UE 800. The RF unit 914 may be further configured to perform analog beamforming in conjunction with the digital beamforming. Although shown as integrated together in transceiver 910, the modem subsystem 912 and/or the RF unit 914 may be separate devices that are coupled together at the network unit 900 to enable the network unit 900 to communicate with other devices.

The RF unit 914 may provide the modulated and/or processed data, e.g. data packets (or, more generally, data messages that may contain one or more data packets and other information), to the antennas 916 for transmission to one or more other devices. This may include, for example, a configuration indicating a plurality of sub-slots within a slot according to aspects of the present disclosure. The antennas 916 may further receive data messages transmitted from other devices and provide the received data messages for processing and/or demodulation at the transceiver 910. The antennas 916 may include multiple antennas of similar or different designs in order to sustain multiple transmission links.

In some instances, the network unit 900 can include multiple transceivers 910 implementing different RATs (e.g., NR and LTE). In some instances, the network unit 900 can include a single transceiver 910 implementing multiple RATs (e.g., NR and LTE). In some instances, the transceiver 910 can include various components, where different combinations of components can implement RATs.

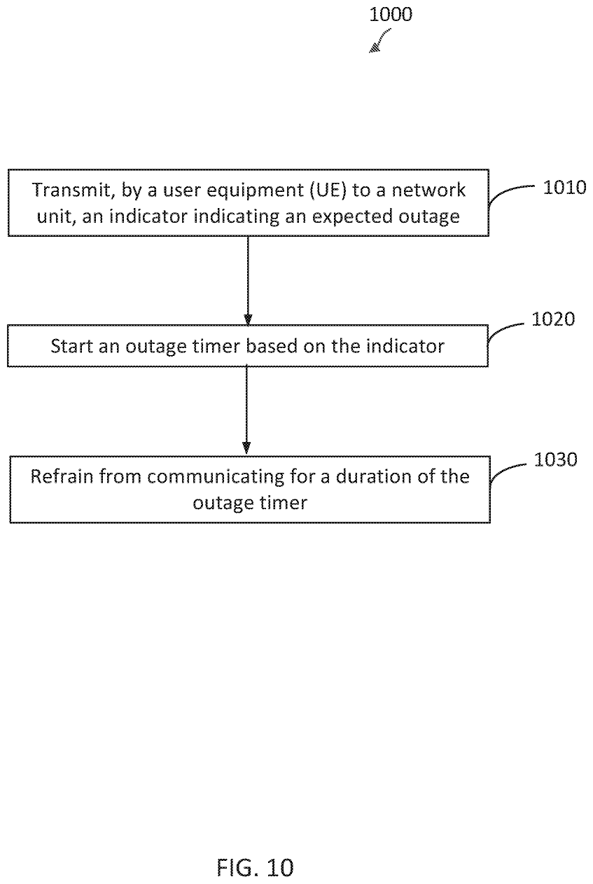

FIG. 10 is a flow diagram of a communication method 1000 according to some aspects of the present disclosure. Aspects of the method 1000 can be executed by a computing device (e.g., a processor, processing circuit, and/or other suitable component) of a wireless communication device or other suitable means for performing the actions. For example, a wireless communication device, such as the UE 115 or the UE 800, may utilize one or more components, such as the processor 802, the memory 804, the network outage module 808, the transceiver 810, the modem 812, and the one or more antennas 816, to execute aspects of method 1000. The method 1000 may employ similar mechanisms as in the networks 100 and 200 and the aspects and actions described with respect to FIGS. 3-7. As illustrated, the method 1000 includes a number of enumerated actions, but the method 1000 may include additional actions before, after, and in between the enumerated actions. In some aspects, one or more of the enumerated actions may be omitted or performed in a different order.

At action 1010, the method 1000 includes a UE (e.g., the UE 115 or the UE 800) transmitting an indicator to a network unit (e.g., the network unit 900, the BS 105, the RU 240, the DU 230, and/or the CU 210) indicating an expected outage. In this regard, the UE may transmit the indicator via at least one of a radio resource control (RRC) message, a medium access control control element (MAC-CE) communication, or other suitable communication. For example, the MAC-CE may include codepoint(s) indicating the expected outage, a duration of the expected outage, a type of call (e.g., normal or emergency) prior to entering the outage, and/or other suitable parameters associated with the expected outage. In some aspects, the UE may transmit the indicator via a UEAssistanceInformation information element. For example, the UEAssistanceInformation information element may include codepoint(s) indicating the expected outage, a duration of the expected outage, a type of call (e.g., normal or emergency) prior to entering the outage and/or other suitable parameters associated with the expected outage. The outage may include a communication network outage (e.g., an outage of the communication network 100 and/or 200). For example, the UE may be a mobile UE that is entering a geographic area or other location that does not have network coverage (e.g., a service outage) and/or sufficient coverage to continue an existing communication session. For example, the UE may enter an elevator lift, a building, an outdoor area, or other location in which the UE does not have network service. In some aspects, the outage may be a reduced service outage. For example, when the UE is in certain locations, the network service may be unable to provide sufficient resources for a current or scheduled session. The session(s) may require certain parameters (e.g., latency, bandwidth, block error rate, etc.) of the network service to satisfy a minimum quality of service. A reduced service outage may be unable to satisfy the minimum quality of service for the session(s). In some aspects, the UE may operate using mm Wave communications and directional beams. In this case, the UE may experience more frequent outages as compared to the UE using lower frequency, non mmWave communications. Aspects of the present disclosure may provide methods of reducing UE power consumption during the outage by placing the UE in a low power mode for the duration of the outage.

In some aspects, the UE may determine the expected network outage or reduced service outage based on sensor inputs. For example, the UE may include one or more sensors (e.g., light sensors, acoustic sensors, RF sensors, location sensors, etc.) that provide measurements to the UE. The UE may determine, based on the measurements, that the UE is expected to enter, or is in, an area without network coverage and experience the outage. In some aspects, the UE may store locations associated with known outages and reduced service outages (e.g., based on experiencing one or more previous outages in the location(s)). The UE may expect to experience an outage when re-entering those locations. The UE may compare its current location and/or expected future location based on the UEs speed and direction to the known outage locations to determine if an outage is expected. In some aspect, the UE may determine its location based on GPS signals, RF triangulation, or other suitable location determining method(s).

In some aspects, the UE may determine an expected outage based on input from a user of the UE. For example, the user of the UE may have knowledge of entering an expected outage area. The user may enter an input to the UE (e.g., via a user interface, including inputs via software and/or hardware) indicating the expected outage.

In some aspects, the indicator indicating the expected outage or reduced service outage may further indicate a duration of the expected outage. The duration of the expected outage may include a time span during which the UE is expected to be without network coverage. For example, the UE may determine the duration of the expected outage based on previous outages at certain locations, UE mobility, and/or other factors. For example, the UE may store locations and outage durations associated with past outages. When the UE approaches and/or enters an outage location, the UE may determine the outage duration (e.g., an estimated outage duration) based on the previously stored outage durations.

At action 1020, the method 1000 includes the UE starting an outage timer. The outage timer may be based on an outage duration (e.g., the expected time in which the UE expects to experience the network service outage or reduced service outage). In some aspects, the UE may enter a low power mode (e.g., a sleep mode) for the duration of the outage timer. In this way, the UE may conserve battery power for the duration of the outage. The UE may determine that certain components of the UE may enter the low power mode and certain components may not enter a low power mode (e.g., continue operating in a connected state and/or full power mode). For example, a processor (e.g., processor 802), a memory (e.g., memory 804), and a transceiver (e.g., transceiver 810) may enter a low power mode while other components of the UE (e.g., application processor, display, WiFi modem, etc.) may not enter a low power mode.

In some aspects, the UE may store (e.g., store in memory 804), a context associated with the UE prior to entering the low power mode. In this way, in some instances the UE may restore the context when waking up from the low power mode. The context may include information associated with one or more sessions active when the outage is expected. For example, if the UE was transmitting content to a network unit when the outage was expected, the UE may store information indicating the portion of the content remaining to be transmitted to the network unit when the UE wakes up from low power mode and network service is restored. The context information stored before the UE enters the low power mode may include processor (e.g., processor 802) register contents, cache memory contents, pointers, bookmarks, process states, operating system kernel states, transceiver (e.g., transceiver 810) configurations. After the UE wakes up from low power mode, the context information may be restored.

At action 1030, the method 1000 includes the UE refraining from communicating for a duration of the outage timer. In this regard, the UE may refrain from transmitting for the duration of the outage timer. Additionally or alternatively, the UE may refrain from monitoring for a communication from the network unit for the duration of the outage timer. The UE may refrain from communicating for a duration of the outage timer based on the UE entering a low power mode during the outage. The UE may enter the lower power mode to conserve battery power for the duration of the expected outage.

In some aspects, the UE may establish a session (e.g., a data session, a voice session) with the network unit prior to the expected outage. The UE may pause the session during the outage by storing the session context prior to entering low power mode and then restoring the session upon expiration of the outage timer. In some instances, the UE may restore the session by resuming communication with the network unit upon expiration of the outage timer. In some aspects, the UE may perform a cell search and/or beam recovery procedure to resume communicating with the network unit. Upon reestablishing a connection (e.g., RRC connected mode) with the network unit, the UE may restore the session context and continue the session. In some aspects, the session may include a voice call. When the voice call is paused due to the service outage, the UE may transmit the indicator to the network unit further indicating a request for the network unit to transmit a call “on hold” message to other UE(s) and/or devices engaged in the voice call. In this way, a user of the other UE(s) and/or devices may know the voice session has been placed on hold (e.g., paused). In some aspects, the “on hold” message may include an indicator indicating the expected hold time based on the outage timer. After the UE reestablishes the connection and the voice session with the network unit, the network unit may transmit a “call resumed” message to the other UE(s).

In some aspects, the UE may establish communication with a different network unit (e.g., a second network unit) upon expiration of the outage timer. For example, when the outage timer expires, the UE may no longer be in the coverage area of the network unit (e.g., a first network unit) that the UE was previously communicating with and the UE may be in a coverage area of the second network unit (e.g., different than the first network unit). The UE may establish a connection with the second network unit and restore the session through the second network unit. In this regard, the UE may transmit a request to the second network unit for restoring the session. In some aspects, the UE may transmit an indicator to the second network unit indicating an identifier of the first network unit. The second network unit may transmit a request to the first network unit requesting the context associated with the session that was stored by the first network unit prior to pausing the session. The second network unit may receive the session context from the first network unit and restore (e.g., resume) the session with the UE.

In some aspects, the UE may determine that it has entered an area having network coverage prior to expiration of the outage timer. In this regard, the UE may determine it has entered an area having network coverage based on its location.

Additionally or alternatively, the UE may periodically wake up from the low power state to check whether the UE has network coverage. For example, the UE may monitor for a PSS and SSS to acquire slot synchronization with the network unit and to identify the cell number associated with the network. In some aspects, the UE may monitor for demodulation reference signal(s) to determine the signal quality (e.g., RSRP) in the cell. The UE may decode information on the broadcast channel (BCH) and decode the master information block (MIB) to acquire details about the cell.

When the UE determines that it has entered an area having network coverage prior to expiration of the outage timer, the UE may reestablish a connection (e.g., RRC connected mode) with the network unit and transmit an indicator to the network unit cancelling the expected outage indicator. The UE may reestablish the connection with the network unit using a cell recovery procedure and/or a beam recovery procedure.

In some aspects, the UE may establish communication with a different network unit (e.g., a second network unit) prior to expiration of the outage timer. For example, before the outage timer expires, the UE may no longer be in the coverage area of the network unit (e.g., a first network unit) that the UE was previously communicating with and the UE may be in a coverage area of the second network unit (e.g., different than the first network unit). The UE may establish a connection with the second network unit and restore the session through the second network unit.

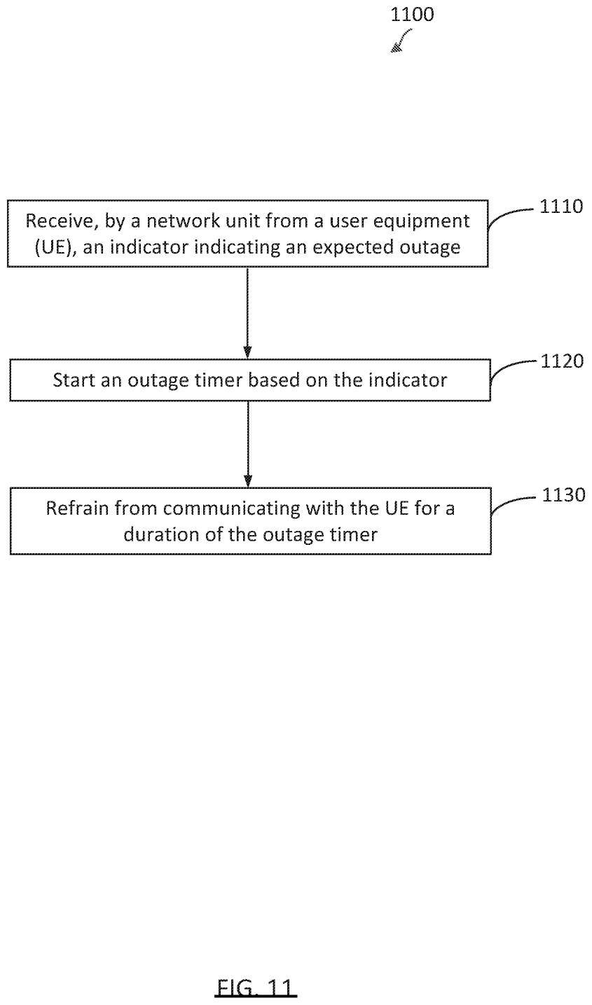

FIG. 11 is a flow diagram of a communication method 1100 according to some aspects of the present disclosure. Aspects of the method 1100 can be executed by a computing device (e.g., a processor, processing circuit, and/or other suitable component) of a wireless communication device or other suitable means for performing the actions. For example, a wireless communication device, such as the network unit 900, the BS 105, the RU 240, the DU 230, and/or the CU 210, may utilize one or more components, such as the processor 902, the memory 904, the network outage module 908, the transceiver 910, the modem 912, and the one or more antennas 916, to execute aspects of method 1100. The method 1100 may employ similar mechanisms as in the networks 100 and 200 and the aspects and actions described with respect to FIGS. 3-7. As illustrated, the method 1100 includes a number of enumerated actions, but the method 1100 may include additional actions before, after, and in between the enumerated actions. In some aspects, one or more of the enumerated actions may be omitted or performed in a different order.

At action 1110, the method 1100 includes a network unit (e.g., the network unit 900, the BS 105, the RU 240, the DU 230, and/or the CU 210) receiving an indicator from a UE (e.g., the UE 115 or the UE 800) indicating an expected outage. In this regard, the network unit may receive the indicator via at least one of a radio resource control (RRC) message, a medium access control control element (MAC-CE) communication, or other suitable communication. For example, the MAC-CE may include codepoint(s) indicating the expected outage, a duration of the expected outage, a type of call (e.g., normal or emergency) prior to entering the outage, and/or other suitable parameters associated with the expected outage. In some aspects, the network unit may receive the indicator via a UEAssistanceInformation information element. For example, the UEAssistanceInformation information element may include codepoint(s) indicating the expected outage, a duration of the expected outage, a type of call (e.g., normal or emergency) prior to entering the outage and/or other suitable parameters associated with the expected outage. The outage may include a communication network outage (e.g., an outage of the communication network 100 and/or 200). For example, the UE may be a mobile UE that is entering a geographic area or other location that does not have network coverage (e.g., a service outage) and/or sufficient coverage to continue an existing communication session. For example, the UE may enter an elevator lift, a building, an outdoor area, or other location in which the UE does not have network service. In some aspects, the outage may be a reduced service outage. For example, when the UE is in certain locations, the network service may be unable to provide sufficient resources for a current or scheduled session. The session(s) may require certain parameters (e.g., latency, bandwidth, block error rate, etc.) of the network service to satisfy a minimum quality of service. A reduced service outage may be unable to satisfy the minimum quality of service for the session(s). In some aspects, the network unit and the UE may operate using mmWave communications and directional beams. In this case, the UE may experience more frequent outages as compared to the network unit and the UE using lower frequency, non mm Wave communications. Aspects of the present disclosure may provide methods of reducing UE power consumption during the outage by placing the UE in a low power mode for the duration of the outage.

In some aspects, the UE may determine the expected network outage or reduced service outage based on sensor inputs. For example, the UE may include one or more sensors (e.g., light sensors, acoustic sensors, RF sensors, location sensors, etc.) that provide measurements to the UE. The UE may determine, based on the measurements, that the UE is expected to enter, or is in, an area without network coverage and experience the outage. In some aspects, the UE may store locations associated with known outages and reduced service outages (e.g., based on experiencing one or more previous outages in the location(s)). The UE may expect to experience an outage when re-entering those locations. The UE may compare its current location and/or expected future location based on the UEs speed and direction to the known outage locations to determine if an outage is expected. In some aspect, the UE may determine its location based on GPS signals, RF triangulation, or other suitable location determining method(s).

In some aspects, the UE may determine an expected outage based on input from a user of the UE. For example, the user of the UE may have knowledge of entering an expected outage area. The user may enter an input to the UE (e.g., via a user interface, including inputs via software and/or hardware) indicating the expected outage.

In some aspects, the indicator indicating the expected outage or reduced service outage may further indicate a duration of the expected outage. The duration of the expected outage may include a time span during which the UE is expected to be without network coverage. For example, the UE may determine the duration of the expected outage based on previous outages at certain locations, UE mobility, and/or other factors. For example, the UE may store locations and outage durations associated with past outages. When the UE approaches and/or enters an outage location, the UE may determine the outage duration (e.g., an estimated outage duration) based on the previously stored outage durations.

At action 1120, the method 1100 includes the network unit starting an outage timer. The outage timer may be based on an outage duration (e.g., the expected time in which the UE expects to experience the network service outage or reduced service outage). In some aspects, the UE may enter a low power mode (e.g., a sleep mode) for the duration of the outage timer. In this way, the UE may conserve battery power for the duration of the outage. The UE may determine that certain components of the UE may enter the low power mode and certain components may not enter a low power mode (e.g., continue operating in a connected state and/or full power mode). For example, a processor (e.g., processor 802), a memory (e.g., memory 804), and a transceiver (e.g., transceiver 810) may enter a low power mode while other components of the UE (e.g., application processor, display, WiFi modem, etc.) may not enter a low power mode.

In some aspects, the network unit may store (e.g., store in memory 904), a context associated with a session of the UE. In this way, in some instances the network unit may restore the context when reestablishing a connection with the UE. The context may include information associated with one or more sessions active when the outage is expected. For example, if the network unit was receiving content from the UE when the outage was expected, the network unit may store information indicating the portion of the content remaining to be transmitted to the network unit when the UE wakes up from low power mode and network service is restored. The context information stored may include processor (e.g., processor 902) register contents, cache memory contents, pointers, bookmarks, process states, operating system kernel states, transceiver (e.g., transceiver 910) configurations. After the session is reestablished, the context information may be restored.

At action 1130, the method 1100 includes the network unit refraining from communicating with the UE for a duration of the outage timer. In this regard, the network unit may refrain from transmitting communications to the UE for the duration of the outage timer. Additionally or alternatively, the network unit may refrain from monitoring for a communication from the UE for the duration of the outage timer. The UE may refrain from communicating for a duration of the outage timer based on the UE entering a low power mode during the outage. The UE may enter the lower power mode to conserve battery power for the duration of the expected outage. The network unit may refrain from allocating resources (e.g., time resources, frequency resources) to the UE during for the duration of the outage timer. In some aspects, the network unit may reallocate resources that were allocated to the UE to other UE(s) for the duration of the outage timer thereby conserving network resources and increasing network capacity.

In some aspects, the network unit may establish a session (e.g., a data session, a voice session) with the UE prior to the expected outage. The network unit may pause the session during the outage by storing the session context and then restoring the session upon expiration of the outage timer. In some instances, the network unit may restore the session by resuming communication with the UE upon expiration of the outage timer. In some aspects, the network unit and/or UE may perform a cell search and/or beam recovery procedure to resume communicating. Upon reestablishing a connection (e.g., RRC connected mode) with the UE, the network unit may restore the session context and continue the session. In some aspects, the session may include a voice call. When the voice call is paused due to the service outage, the network unit may receive an indicator from the UE indicating a request for the network unit to transmit a call “on hold” message to other UE(s) and/or devices engaged in the voice call. In this way, a user of the other UE(s) and/or devices may know the voice session has been placed on hold (e.g., paused). In some aspects, the “on hold” message may include an indicator indicating the expected hold time based on the outage timer. After the UE reestablishes the connection and the voice session with the network unit, the network unit may transmit a “call resumed”message to the other UE(s).

In some aspects, the UE may establish communication with a different network unit (e.g., a second network unit) upon expiration of the outage timer. For example, when the outage timer expires, the UE may no longer be in the coverage area of the network unit (e.g., a first network unit) that the UE was previously communicating with and the UE may be in a coverage area of the second network unit (e.g., different than the first network unit). The UE may establish a connection with the second network unit and restore the session through the second network unit. In this regard, the UE may transmit a request to the second network unit for restoring the session. In some aspects, the UE may transmit an indicator to the second network unit indicating an identifier of the first network unit. The second network unit may transmit a request to the first network unit requesting the context associated with the session that was stored by the first network unit prior to pausing the session. The second network unit may receive the session context from the first network unit and restore (e.g., resume) the session with the UE.

In some aspects, the UE may determine that it has entered an area having network coverage prior to expiration of the outage timer. In this regard, the UE may determine it has entered an area having network coverage based on its location. Additionally or alternatively, the UE may periodically wake up from the low power state to check whether the UE has network coverage. For example, the UE may monitor for a PSS and SSS to acquire slot synchronization with the network unit and to identify the cell number associated with the network. In some aspects, the UE may monitor for demodulation reference signal(s) to determine the signal quality (e.g., RSRP) in the cell. The UE may decode information on the broadcast channel (BCH) and decode the master information block (MIB) to acquire details about the cell.

When the UE determines that it has entered an area having network coverage prior to expiration of the outage timer, the network unit may reestablish a connection (e.g., RRC connected mode) with the UE and receive an indicator from the UE cancelling the expected outage indicator. The UE may reestablish the connection with the network unit using a cell recovery procedure and/or a beam recovery procedure.

In some aspects, the UE may establish communication with a different network unit (e.g., a second network unit) prior to expiration of the outage timer. For example, before the outage timer expires, the UE may no longer be in the coverage area of the network unit (e.g., a first network unit) that the UE was previously communicating with and the UE may be in a coverage area of the second network unit (e.g., different than the first network unit). The UE may establish a connection with the second network unit and restore the session through the second network unit.

Further aspects of the present disclosure include the following:

Aspect 1 includes a method of wireless communication performed by a user equipment (UE), the method comprising transmitting, to a network unit, an indicator indicating an expected outage; starting an outage timer based on the indicator; and refraining from communicating for a duration of the outage timer.

Aspect 2 includes the method of aspect 1, wherein the transmitting the indicator comprises transmitting the indicator via at least one of a radio resource control (RRC) message or a medium access control control element (MAC-CE) communication.

Aspect 3 includes the method of any of aspects 1-2, wherein the transmitting the indicator comprises transmitting the indicator via a UEAssistanceInformation information element.

Aspect 4 includes the method of any of aspects 1-3, wherein the indicator further indicates a duration of the expected outage.

Aspect 5 includes the method of any of aspects 1-4, further comprising refraining from monitoring for a communication for the duration of the outage timer.

Aspect 6 includes the method of any of aspects 1-5, wherein the indicator is based on a location of the UE.

Aspect 7 includes the method of any of aspects 1-6, further comprising receiving a global positioning system (GPS) signal, wherein the location is based on the GPS signal.

Aspect 8 includes the method of any of aspects 1-7, further comprising receiving one or more sensor inputs, wherein the location is based on the one or more sensor inputs.

Aspect 9 includes the method of any of aspects 1-8, wherein the indicator is based on an input to a user interface of the UE.

Aspect 10 includes the method of any of aspects 1-9, further comprising entering a low power mode for the duration of the outage timer; and storing a context associated with the UE prior to entering the low power mode.

Aspect 11 includes the method of any of aspects 1-10, further comprising transmitting, to the network unit, an indicator indicating an expiration of the outage timer; and establishing a connection with the network unit.

Aspect 12 includes the method of any of aspects 1-11, further comprising establishing a connection with a second network unit after expiration of the outage timer, wherein the second network unit is different from the network unit.

Aspect 13 includes the method of any of aspects 1-12, further comprising transmitting, to the network unit prior to expiration of the outage timer, an indicator cancelling the expected outage.

Aspect 14 includes the method of any of aspects 1-13, further comprising establishing, prior to transmitting the indicator, a session with the network unit, wherein the indicator further indicates a session type.

Aspect 15 includes the method of any of aspects 1-14, further comprising establishing, prior to transmitting the indicator, a session with the network unit; pausing the session for the duration of the outage timer; and re-establishing the session with the network unit based on expiration of the outage timer.

Aspect 16 includes the method of any of aspects 1-15, further comprising receiving, from a wireless communication operator via the network unit, a configuration associated with the expected outage; and performing, based on the configuration, a cell search during the expected outage.

Aspect 17 includes a method of wireless communication performed by a network unit, the method comprising receiving, from a user equipment (UE), an indicator indicating an expected outage; starting an outage timer based on the indicator; and refraining from communicating with the UE for a duration of the outage timer.

Aspect 18 includes the method of aspect 17, wherein the receiving the indicator comprises receiving the indicator via at least one of a radio resource control (RRC) message or a medium access control control element (MAC-CE) communication.

Aspect 19 includes the method of any of aspects 17-18, wherein the receiving the indicator comprises receiving the indicator via a UEAssistanceInformation information element.

Aspect 20 includes the method of any of aspects 17-19, wherein the indicator further indicates a duration of the expected outage.

Aspect 21 includes the method of any of aspects 17-20, further comprising refraining from monitoring for a communication from the UE for the duration of the outage timer; and refraining from allocating resources to the UE for the duration of the outage timer.

Aspect 22 includes the method of any of aspects 17-21, wherein the indicator is based on a location of the UE.

Aspect 23 includes the method of any of aspects 17-22, further comprising determining a location of the UE; and transmitting, to the UE, an indicator indicating the location of the UE.

Aspect 24 includes the method of any of aspects 17-23, wherein the location is based on one or more sensor inputs to the UE.

Aspect 25 includes the method of any of aspects 17-24, wherein the indicator is based on an input to a user interface of the UE.

Aspect 26 includes the method of any of aspects 17-25, further comprising storing a context associated with the UE.

Aspect 27 includes the method of any of aspects 17-26, further comprising transmitting, to a second network unit, the context associated with the UE.

Aspect 28 includes the method of any of aspects 17-27, further comprising receiving, from the UE, an indicator indicating an expiration of the outage timer; and establishing a connection with the UE.

Aspect 29 includes the method of any of aspects 17-28, further comprising receiving, from the UE prior to expiration of the outage timer, an indicator cancelling the expected outage.

Aspect 30 includes the method of any of aspects 17-29, further comprising establishing, prior to receiving the indicator, a session with the UE; pausing the session for the duration of the outage timer; and re-establishing the session with the UE based on expiration of the outage timer.

Aspect 31 includes a non-transitory computer-readable medium storing one or more instructions for wireless communication, the one or more instructions comprising one or more instructions that, when executed by one or more processors of a user equipment (UE) cause the UE to perform any one of aspects 1-16.

Aspect 32 includes a non-transitory computer-readable medium storing one or more instructions for wireless communication, the one or more instructions comprising one or more instructions that, when executed by one or more processors of a network unit, cause the network unit to perform any one of aspects 17-30.

Aspect 33 includes a user equipment (UE) comprising one or more means to perform any one or more of aspects 1-16.

Aspect 34 includes a network unit comprising one or more means to perform any one or more of aspects 17-30.

Aspect 35 includes a user equipment (UE) comprising a memory; a transceiver; and at least one processor coupled to the memory and the transceiver, wherein the UE is configured to perform any one or more of aspects 1-16.

Aspect 36 includes a network unit comprising a memory; a transceiver; and at least one processor coupled to the memory and the transceiver, wherein the network unit is configured to perform any one or more of aspects 17-30.

Information and signals may be represented using any of a variety of different technologies and techniques. For example, data, instructions, commands, information, signals, bits, symbols, and chips that may be referenced throughout the above description may be represented by voltages, currents, electromagnetic waves, magnetic fields or particles, optical fields or particles, or any combination thereof.

The various illustrative blocks and modules described in connection with the disclosure herein may be implemented or performed with a general-purpose processor, a DSP, an ASIC, an FPGA or other programmable logic device, discrete gate or transistor logic, discrete hardware components, or any combination thereof designed to perform the functions described herein. A general-purpose processor may be a microprocessor, but in the alternative, the processor may be any conventional processor, controller, microcontroller, or state machine. A processor may also be implemented as a combination of computing devices (e.g., a combination of a DSP and a microprocessor, multiple microprocessors, one or more microprocessors in conjunction with a DSP core, or any other such configuration).

The functions described herein may be implemented in hardware, software executed by a processor, firmware, or any combination thereof. If implemented in software executed by a processor, the functions may be stored on or transmitted over as one or more instructions or code on a computer-readable medium. Other examples and implementations are within the scope of the disclosure and appended claims. For example, due to the nature of software, functions described above can be implemented using software executed by a processor, hardware, firmware, hardwiring, or combinations of any of these. Features implementing functions may also be physically located at various positions, including being distributed such that portions of functions are implemented at different physical locations. Also, as used herein, including in the claims, “or” as used in a list of items (for example, a list of items prefaced by a phrase such as “at least one of” or “one or more of”) indicates an inclusive list such that, for example, a list of [at least one of A, B, or C] means A or B or C or AB or AC or BC or ABC (i.e., A and B and C).

As those of some skill in this art will by now appreciate and depending on the particular application at hand, many modifications, substitutions and variations can be made in and to the materials, apparatus, configurations and methods of use of the devices of the present disclosure without departing from the spirit and scope thereof. In light of this, the scope of the present disclosure should not be limited to that of the particular instances illustrated and described herein, as they are merely by way of some examples thereof, but rather, should be fully commensurate with that of the claims appended hereafter and their functional equivalents.

1. A method of wireless communication performed by a user equipment (UE), the method comprising:
transmitting, to a network unit, an indicator indicating an expected outage; starting an outage timer based on the indicator; and
refraining from communicating for a duration of the outage timer.

2. The method of claim 1, wherein the transmitting the indicator comprises transmitting the indicator via at least one of a radio resource control (RRC) message or a medium access control control element (MAC-CE) communication.

3. The method of claim 1, wherein the transmitting the indicator comprises transmitting the indicator via a UEAssistanceInformation information element.

4. The method of claim 1, wherein the indicator further indicates a duration of the expected outage.

5. The method of claim 1, further comprising:
refraining from monitoring for a communication for the duration of the outage timer.

6. The method of claim 1, wherein the indicator is based on a location of the UE.

7. The method of claim 1, further comprising:
entering a low power mode for the duration of the outage timer; and
storing a context associated with the UE prior to entering the low power mode.

8. The method of claim 1, further comprising:
establishing a connection with a second network unit after expiration of the outage timer, wherein the second network unit is different from the network unit.

9. (canceled)

10. A method of wireless communication performed by a network unit, the method comprising:
receiving, from a user equipment (UE), an indicator indicating an expected outage;
starting an outage timer based on the indicator; and
refraining from communicating with the UE for a duration of the outage timer.

11. The method of claim 10, wherein the receiving the indicator comprises receiving the indicator via a UEAssistanceInformation information element.

12. The method of claim 10, further comprising:
refraining from monitoring for a communication from the UE for the duration of the outage timer; and
refraining from allocating resources to the UE for the duration of the outage timer.

13. The method of claim 10, further comprising:
determining a location of the UE; and
transmitting, to the UE, an indicator indicating the location of the UE.

14-15. (canceled)

16. A user equipment (UE) comprising:
a memory;
a transceiver; and
at least one processor coupled to the memory and the transceiver, wherein the UE is configured to:
transmit, to a network unit, an indicator indicating an expected outage; start an outage timer based on the indicator; and
refrain from communicating for a duration of the outage timer.

17. The UE of claim 16, wherein the UE is further configured to transmit the indicator via at least one of a radio resource control (RRC) message or a medium access control control element (MAC-CE) communication.

18. The UE of claim 16, wherein the UE is further configured to transmit the indicator via a UEAssistanceInformation information element.

19. The UE of claim 16, wherein the indicator further indicates a duration of the expected outage.

20. The UE of claim 16, wherein the UE is further configured to:
refrain from monitoring for a communication for the duration of the outage timer.

21. The UE of claim 16, wherein the indicator is based on a location of the UE.

22. The UE of claim 16, wherein the UE is further configured to:
enter a low power mode for the duration of the outage timer; and
store a context associated with the UE prior to entering the low power mode.

23. The UE of claim 16, wherein the UE is further configured to:
establish a connection with a second network unit after expiration of the outage timer, wherein the second network unit is different from the network unit.

24-30. (canceled)
